(19) United States
(12) Patent Application Publication
(10) Pub. No.: US 2024/0336776 A1
(43) Pub. Date: Oct. 10, 2024

(54) POLYAMIDE COMPOSITIONS AND ARTICLE

(71) Applicant: BASF SE, Ludwigshafen am Rhein (DE)

(72) Inventors: Lin CHEN, Shanghai (CN); Rui DOU, Shanghai (CN); Bangaru Dharmapuri Sriramulu SAMPATH, Shanghai (CN); LU PING H. ZHAO, Shanghai (CN)

(21) Appl. No.: 18/682,346

(22) PCT Filed: Aug. 22, 2022
(86) PCT No.: PCT/EP2022/073279

§ 371 Date: Feb. 8, 2024

(30) Foreign Application Priority Data
Aug. 30, 2021 (WO) PCT/CN2021/115388

(51) Int. Cl. C08L 77/00; C08K 5/3492; C08K 5/5313; C08L 73/00

(52) U.S. Cl. CPC C08L 77/00; C08K 5/34924; C08K 5/5313; C08L 73/00; C08L 2201/02; C08L 2203/12; C08L 2203/16; C08L 2203/20

(57) ABSTRACT

Described herein is a polyamide composition, including: (A) 10 to 60% by weight of a polyamide, (B) 10 to 60% by weight of a polyketone, (C) 5 to 25% by weight of a flame retardant, and (D) 0.5 to 10% by weight of a flame retardant synergist, each being based on the total weight of the polyamide composition, where the polyamide has at least one type of structural units of more than 6 carbon atoms. Also described herein is an article produced from the polyamide composition.

### FIELD OF THE INVENTION

The present invention relates to a polyamide (PA) composition, and an article produced from the same.

### BACKGROUND OF THE INVENTION

Polyamide (also referred to as nylon) is a kind of polymer that contains repeating amido moieties (—CONH—) in the main chain of the polymer. Nowadays polyamide is widely used as structural materials in various industries (automotive, appliance, etc.) due to its good processibility and mechanical properties and low cost. Among all kinds of polyamides, polyamide 6 and polyamide 66 are widely used in many different markets and applications due to their excellent performance and cost ratios. However, they have poor dimensional stability and high water absorption, which restrict the applications in electronics field. Thanks to the lower water absorption, abrasion resistance and chemical resistance, long chain polyamides have advantages in electrical and automobile markets.

Except for the advantages above, the frame retardancy of long chain polyamides are not so satisfying. Common flame retardant agents such as halogen based, phosphate based show good effects in polyamide 6, polyamide 66, but the flame retardant effect for long chain polyamides is quite limited.

TW201114825A1 describes a series of flame retardants having structure of any of formula b. 1 to b.6, and the polyamide composition thereof. As described in the description, UL94 V-0 with a sample thickness of 0.8 mm could only be achieved by the mixture of a flame retardant synergist and the flame retardant in an amount of over 10 wt % respectively. Moreover, the flame retardant having formula b. 1 to b.6 are not commercialized yet.

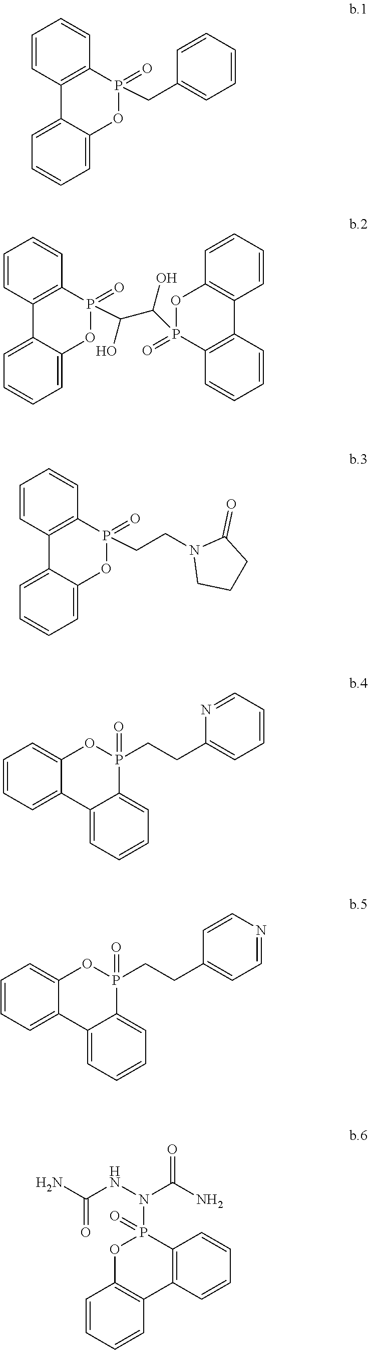 [SMILES: O=P1(Cc2ccccc2)Oc2ccccc2-c2ccccc21 ; O=P1(C(O)C(O)P2(=O)Oc3ccccc3-c3ccccc32)Oc2ccccc2-c2ccccc21 ; O=C1CCCN1CCP1(=O)Oc2ccccc2-c2ccccc21 ; O=P1(CCc2ccccn2)Oc2ccccc2-c2ccccc21 ; O=P1(CCc2ccncc2)Oc2ccccc2-c2ccccc21 ; NC(=O)NN(C(N)=O)P1(=O)Oc2ccccc2-c2ccccc21]

CN104744935A describes a long-chain thermal conductive polyamide composition, which includes 20 to 40 wt % of long-chain polyamide, 30 to 50 wt % of thermal conductive filler, 5 to 20 wt % of reinforcing agent, 5 to 20 wt % of non-halogen flame retardant and other additives. Although non-halogen flame retardant is used in the polyamide composition in a general amount, the flame retardancy of the polyamide composition according to UL94 (0.8 mm) is still V-2, which can't achieve the same level of nylon 6 or 66.

US2008/0085956A1 describes a flame retardant thermoplastic composition comprising a blend of PA-11 and PA-12 polyamide resins and melamine cyanurate, wherein the PA-12/PA-11 ratio is in the range from 90/10 to 50/50. The flame retardancy of such a composition can only achieve V-2 (Example 3) and V-0 (Example 4) according to UL94 (1.6 mm), but still can't realize V-O according to UL94 (0.8 mm). It's known that for the same material, it's more difficult to realize V-O in a thinner thickness.

Thus, there is a need to provide a polyamide composition having good flame retardancy, low moisture uptake, and good mechanical properties.

### SUMMARY OF THE INVENTION

The object of the present invention is to provide a polyamide composition having good flame retardancy, low moisture uptake, and good mechanical properties.

Accordingly, the present invention provides a polyamide composition, comprising
(A) 10 to 60% by weight of a polyamide,
(B) 10 to 60% by weight of a polyketone,
(C) 5 to 25% by weight of a flame retardant, and
(D) 0.5 to 10% by weight of a flame retardant synergist, each being based on the total weight of the polyamide composition, wherein the polyamide has at least one type of structural unit of more than 6 carbon atoms.

The present invention also provides an article produced from the polyamide composition as described herein.

It has been found that the polyamide composition according to the present invention has good flame retardancy, low moisture uptake, and good mechanical properties. Articles having good flame retardancy, low moisture uptake, and good mechanical properties have been produced from the polyamide composition according to the present invention, with no discoloration (i.e., yellowing) occurring during extrusion or injection of the polyamide composition according to the present invention, which shows good color stability of the polyamide composition during processing.

### DETAILED DESCRIPTION OF THE INVENTION

The present invention will be described in detail hereinafter. It is to be understood that the present invention can be embodied in many different ways and shall not be construed as limited to the embodiments set forth herein.

The singular forms “a”, “an” and “the” include plural referents unless the context clearly dictates otherwise. The terms “comprise”, “comprising”, etc. are used interchangeably with “contain”, “containing”, etc. and are to be interpreted in a non-limiting, open manner. That is, e.g., further components or elements can be present. The expressions “consists of” or “consists essentially of” or cognates can be embraced within “comprises” or cognates.

As used herein, the term “polyamide” can be abbreviated as “PA”, and the polyamide having at least one type of structural unit of more than 6 carbon atoms can be referred as “long chain polyamide” (LCPA).

As used herein, the term “structural unit(s)” is intended to refer to the minimal molecular residue(s) resulting from respective monomer molecules after polymerization. For example, PA6 has a type of structural unit of —NH(CH₂)₅CO—, PA66 has two types of structural units, i.e., —NH(CH₂)₆NH-and-CO(CH₂)₄CO—, PA510 have two types of structural units, i.e., —NH(CH₂)₅NH-and-CO(CH₂)₈CO—, PA1010 have two types of structural units, i.e., —NH(CH₂)₁₀NH-and-CO(CH₂)₈CO—, and so on.

As used herein, the term “repeating unit(s)” is intended to refer to the minimal unit(s) with same chemical composition in a polymer. The repeating units can consist of one or more types of structural units. For example, PA6 has repeating units same as the structural units, i.e., —NH(CH₂)₅CO—; PA66 has repeating units of —NH(CH₂)₆NHCO(CH₂) 4CO-which consist of two types of structural units, i.e., —NH(CH₂)₆NH-and-CO(CH₂)₄CO—; PA510 has repeating units of —NH(CH₂)₅NHCO(CH₂)₈CO-which consist of two types of structural units, i.e., —NH(CH₂)₅NH-and-CO(CH₂)₈CO—; PA1010 has repeating units of —NH(CH₂)₁₀NHCO(CH₂)₈CO-which consist of two types of structural units, i.e., —NH(CH₂)₁₀NH-and-CO(CH₂)₈CO—.

### Component (A)

Polyamide is well known in the art and mean a polymer that contains repeating amide groups (—CONH—) in the main chain of the polymers. Generally, polyamide is made up of many identical structural units repeatedly linked by covalent bonds.

Polyamide can be typically derived from at least one monomer which is selected from the group consisting of lactams, amino acids, the combination of dicarboxylic acid and diamine, and the combination of dicarboxylic acid chloride and diamine.

The polyamide of the present invention can have repeating units of Formula (I):

[symbol]

NH—R¹—CO [symbol] Formula (I),

wherein
R¹ is a hydrocarbylene group having from 6 to 40 carbon atoms, preferably from 8 to 19 carbon atoms, more preferably from 8 to 12 carbon atoms.

The polyamide having repeating units of Formula (I) can be typically derived from at least one aliphatic monomer which is selected from the group consisting of (1) lactams having 7 or more carbon atoms and (2) amino acids having 7 or more carbon atoms.

The lactams preferably have from 9 to 20 carbon atoms, more preferably from 9 to 13 carbon atoms. Examples of the lactams include, but are not limited to, caprylolactam, caprinolactam, undecanolactam, laurolactam, and mixtures thereof.

The amino acids preferably have from 9 to 20 carbon atoms, more preferably from 9 to 13 carbon atoms. Examples of the amino acids include, but are not limited to, 9-aminononanoic acid, 10-aminodecanoic acid, 11-aminoundecanoic acid, 12-aminododecanoic acid, and mixtures thereof.

Alternatively, the polyamide of the present invention can have repeating units of Formula (II):

[symbol]

NH—R²—NH—CO—R³—CO [symbol] Formula (II),

wherein
R² is a hydrocarbylene group having from 4 to 40 carbon atoms, preferably from 4 to 24 carbon atoms, more preferably from 4 to 18, most preferably from 4 to 14 carbon atoms, for example 4, 5, 6, 8, 9, 10, 11, 12, 13 or 14 carbon atoms,
R³ is a hydrocarbylene group having from 4 to 40 carbon atoms, preferably from 7 to 36 carbon atoms, more preferably from 8 to 36 carbon atoms, further preferably from 8 to 20 or 34 carbon atoms, most preferably from 8 to 12 or 34 carbon atoms, for example 7, 8, 9, 10, 11, 12, 13, 14, 15, 16, 17, 18 or 34 carbon atoms, and
   wherein R² has more than 6 carbon atoms and/or R³ has more than 4 carbon atoms.

Preferably, R¹, R² and R³ are each independently alkylene group or cycloalkylene group, more preferably alkylene group, having a number of carbon atoms as described herein.

The polyamide of the present invention preferably has the repeating units of Formula (II). Preferably, R² has from 6 to 14 carbon atoms, R³ has from 8 to 36 carbon atoms, more preferably from 8 to 20 or 34 carbon atoms.

The polyamide having repeating units of Formula (II) can be typically derived from aliphatic monomers which are selected from the group consisting of (1) the combination of aliphatic dicarboxylic acids having from 7 to 42 carbon atoms and aliphatic diamines having from 4 to 40 carbon atoms and (2) the combination of aliphatic dicarboxylic acid chlorides having from 7 to 42 carbon atoms and aliphatic diamines having from 4 to 40 carbon atoms.

The aliphatic dicarboxylic acids preferably have from 7 to 20 or 36 carbon atoms, for example 8, 9, 10, 11, 12, 13, 14, 15, 16, 17, 18 or 36 carbon atoms. Examples of the aliphatic dicarboxylic acids include, but are not limited to, pimelic acid, suberic acid, sebacic acid, azelaic acid, sebacic acid, undecanedioic acid, dodecandioic, tridecanedioic acid, tetradecandioic acid, pentadecandioic acid, hexadecanedioic acid, octadecandioic acid, dimer acid having 36 carbon atoms, and mixtures thereof.

The aliphatic diamines preferably have from 4 to 24 carbon atoms, more preferably from 4 to 18 carbon atoms, for example 4, 5, 6, 8, 9, 10, 11, 12, 13 or 14 carbon atoms. The aliphatic diamines can be linear aliphatic diamines or branched aliphatic diamines. Examples of the aliphatic diamines include, but are not limited to, 1,4-butanediamine, 1,5-pentanediamine, 1,6-hexanediamine, 1,7-heptanediamine, 1,8-octanediamine, 1,9-nonanediamine, 1,10-decanediamine, 1,11-undecanediamine, 1,12-dodecanediamine, 1,13-tridecanediamine, 1,14-tetradecanediamine, 1,16-hexadecanediamine, 1,18-octadecanediamine, 1,20-eicosanediamine, 1,22-docosanediamine, 2-methylpentane-1,5-diamine, 3-methylpentane-1,5-diamine, 2,5-dimethylhexane-1,6-diamine, 2,4-dimethylhexane-1,6-diamine, 3,3-dimethylhexane-1,6-diamine, 2,2-dimethylhexane-1,6-diamine, 2,2,4-trimethylhexane-1,6-diamine, 2,4,4-trimethylhexane-1,6-diamine, 2,3-dimethylheptane-1,7-diamine, 2,4-dimethylheptane-1,7-diamine, 2,5-dimethylheptane-1,7-diamine, 2,2-dimethylheptane-1,7-diamine, 2-methyloctane-1,8-diamine, 1,3-dimethyloctane-1,8-diamine, 1,4-dimethyloctane-1,8-diamine, 2,4-dimethyloctane-1,8-diamine, 3,4-dimethyloctane-1,8-diamine, 4,5-dimethyloctane-1,8-diamine, 2,2-dimethyloctane-1,8-diamine, 3,3-dimethyloctane-1,8-diamine, 4,4-dimethyloctane-1,8-diamine, 2,4-diethylhexane-1,6-diamine, 5-methylnonane-1,9-diamine, and mixtures thereof.

The aliphatic dicarboxylic acid chlorides preferably have from 7 to 20 carbon atoms, for example 7, 8, 9, 10, 11, 12, 13, 14, 15, 16, 17 or 18 carbon atoms. Examples of the dicarboxylic acid chlorides include, but are not limited to, heptanedioyl dichloride, azelaoyl chloride (nonanedioyl dichloride), sebacoyl chloride, undecanedioyl dichloride, and mixtures thereof.

In some embodiments, the polyamide can be at least one selected from the group consisting of PA7, PA8, PA9, PA11, PA12, PA410, PA510, PA513, PA515, PA69, PA610, PA612, PA613, PA614, PA618, PA636, PA88, PA810, PA812, PA1010, PA1012, PA1014, PA1018, PA1210, PA1212, PA1214, PA1218, PA1313, PA1410, PA1412, PA1414, PA1418, and any combinations thereof, preferably PA410, PA510, PA513, PA515, PA69, PA610, PA612, PA613, PA614, PA618, PA636, PA88, PA810, PA812, PA1010, PA1012, PA1014, PA1018, PA1210, PA1212, PA1214, PA1218, PA1313, PA1410, PA1412, PA1414, PA1418, and any combinations thereof, even more preferably PA410, PA510, PA610, PA612, PA618, PA1010, PA1012, PA1210, PA1212, and any combinations thereof, further more preferably PA510, PA1010, and any combinations thereof.

Additionally, the polyamide can also be a blend of at least one polyamide as described above and/or copolymerized polyamide (co-polyamide).

The copolymerized polyamide is a polyamide copolymer comprising repeating units of Formula (I) and repeating units of Formula (II), or two or more types of repeating units of Formula (I), or two or more types of repeating units of Formula (II), and optionally comprising at least one type of repeating units of Formula (III) and/or Formula (IV):

[symbol]

NH—R⁴—CO [symbol] Formula (III),

wherein,
R⁴ is a hydrocarbylene group having from 2 to 5 carbon atoms, preferably from 3 to 5 carbon atoms;

[symbol]

NH—R⁵—NH—CO—R⁶—CO [symbol] Formula (IV),

wherein
R⁵ is a hydrocarbylene group having from 2 to 6 carbon atoms, and
R⁶ is a hydrocarbylene group having from 1 to 4 carbon atoms.

Preferably, R⁴, R⁵ and R⁶ are each independently alkylene group or cycloalkylene group, more preferably is alkylene group.

The repeating units of Formula (III) above can be typically derived from at least one aliphatic monomer which is selected from the group consisting of (1) lactams having from 3 to 6 carbon atoms and (2) amino acids having from 3 to 6 carbon atoms.

Examples of the lactams having from 3 to 6 carbon atoms include, but are not limited to, ß-lactam, caprolactam, heptanelactam, and mixtures thereof.

Examples of the amino acids having from 3 to 6 carbon atoms include, but are not limited to, 5-amino-pentanoic acid.

The repeating units of the Formula (IV) above can be typically derived from aliphatic monomers which are selected from the group consisting of (1) the combination of aliphatic dicarboxylic acids having from 3 to 6 carbon atoms and aliphatic diamines having from 2 to 6 carbon atoms; and (2) the combination of aliphatic dicarboxylic acid chlorides having from 3 to 6 carbon atoms and aliphatic diamines having from 2 to 6 carbon atoms.

Examples of the aliphatic dicarboxylic acids having from 3 to 6 carbon atoms include, but are not limited to, malonic acid, succinic acid, glutaric acid, adipic acid, and mixtures thereof.

Examples of the aliphatic diamines having from 2 to 6 carbon atoms include, but are not limited to, 1,2-ethanediamine, 1,2-propanediamine, 1,3-propanediamine, 1,3-butanediamine, 1,4-butanediamine, 1,5-pentanediamine, 1,1-dimentylbutane-1,4-diamine, 1-ethylbutane-1,4-diamine, 1,2-dimethylbutane-1,4-diamine, 1,3-dimethylbutane-1,4-diamine, 1,4-dimethylbutane-1,4-diamine, 2,3-dimethylbutane-1,4-diamine, 1-butylethane-1,2-diamine, 1,6-hexanediamine, and mixtures thereof.

Examples of the aliphatic dicarboxylic acid chlorides having from 3 to 6 carbon atoms include, but are not limited to, glutaryl chloride, adipoyl chloride, and mixtures thereof.

Examples of the repeating units of the Formula (III) and the Formula (IV) include, but are not limited to, —NH(CH₂)₅CO—, —NH(CH₂)₄NHCO(CH₂)₄CO—, —NH(CH₂)₆NHCO(CH₂)₄CO—. Examples of the co-polyamide include, but are not limited to, PA6/PA510, PA6/PA610, PA6/PA612, PA6/PA636, PA6/PA1010, PA66/PA410, PA66/PA510, PA66/PA610, PA66/PA612, or PA66/PA1010.

There is no limitation of the type of the copolymer, including for example block copolymer, random copolymer, graft copolymer and alternating copolymer.

The polyamide in the polyamide composition according to the present invention can have a conventional molecular weight. Preferably, the relative viscosity of the polyamide are from 1.8 to 4.0, as measured in 98 wt % sulfuric acid solution at 25° C.

The polyamide in the polyamide composition according to the present invention can be prepared via known processes or commercially available polyamide materials. Examples of commercially available polyamide materials include, but are not limited to, TERRYL® series from Cathay Biomaterial Co., Ltd, such as TERRYL®PA510, TERRYL®PA511, TERRYL®PA512, TERRYL®PA513, TERRYL®PA514, TERRYL®PA612, TERRYL®PA1012, TERRYL®PA 1212, and PA series from Shandong Dongchen Engineering Plastic Co., Ltd, such as PA610, PA612, PA1010, PA1212, PA1313.

It is preferred that the component (A) is present in the polyamide composition according to the present invention in an amount of 15 to 50% by weight, preferably 20 to 45% by weight, for example 20% by weight, 25% by weight, 30% by weight, 35% by weight, 40% by weight, 45% by weight, based on the total weight of the polyamide composition.

### Component (B)

As used herein, polyketones suitable as component (B) according to the present invention are polymers derived from carbon monoxide and an olefinically unsaturated monomer, which have at least one type of the repeating units of Formula (V):

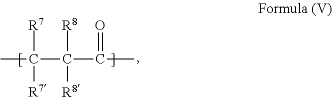

wherein R⁷, R^{7′}, R⁸ and R^{8′} are each independently hydrogen or hydrocarbyl group having from 1 to 40 carbon atoms, preferably 1 to 20 carbon atoms, more preferably 1 to 10 carbon atoms, most preferably from 1 to 5.

In a preferred embodiment, the polyketone having at least two types of the repeating units of Formula (V).

The olefinically unsaturated monomer includes for example alpha-olefins having from 2 to 10 carbon atoms and substituted derivatives thereof, and monocyclic or polycyclic aromatic monomer having from 6 to 30 carbon atoms and alkyl substituted derivatives thereof. Particularly, the olefinically unsaturated monomer is selected from alpha-olefins having from 2 to 8 carbon atoms, such as ethylene, propylene, butylene, isobutylene, pentylene. It is particularly preferred that the olefinically unsaturated monomer is ethylene or a mixture of ethylene and one or more of alpha-olefins having from 3 to 6 carbon atoms, especially propylene or butylene. It is further preferred that the molar ratio of ethylene to the one or more of alpha-olefins having from 3 to 6 carbon atoms is greater than or equal to 1, for example, 2 to 30.

Typically, the polyketone can be a copolymer of ethylene/CO, propylene/CO, butylene/CO, ethylene/propylene/CO or ethylene/butylene/CO, wherein CO represents carbon monoxide.

The polyketones preferably have a number average molecular weight of less than 100,000, more preferably less than 70,000, for example, in the range from 10,000 to 70,000, 30,000 to 70000, or 45,000 to 65,000.

For the purpose of the present invention, the polyketones can be prepared via known processes or commercially available polyketone materials. Examples of commercially available polyketone materials include, but are not limited to, POKETONE series from Hyosung Co. Ltd, such as POKETONE™ M930A, POKETONE™ M930F.

It is preferred that the component (B) is present in the polyamide composition according to the present invention in an amount of 20 to 55% by weight of polyketone, preferably 25 to 50% by weight, for example 25% by weight, 30% by weight, 35% by weight, 40% by weight, 45% by weight, 50% by weight, based on the total weight of the polyamide composition.

### Component (C)

As used herein, flame retardants as component (C), also known as fire retardants, are functional additives that impart flame retardancy to flammable polymers. There is no limitation for the type of the flame retardants used in the polyamide composition according to the present invention, including for example inorganic flame retardants, phosphorus-containing flame retardants, halogen-containing flame retardants and nitrogen-containing flame retardants, etc.

Inorganic flame retardants are generally added into polymers in the form of elements or compounds, and are fully mixed with polymers in a physically dispersed state. For example, red phosphorus is a common inorganic flame retardant, which has high flame retardant efficiency, low dosage, low smoke emission, and low toxicity.

The phosphorus-containing flame retardants have the advantages of low smoke, non-toxic, and halogen-free. The phosphorus-containing flame retardants used herein include, but are not limited to, phosphate, phosphite, phosphonate, phosphinate, pyrophosphate, polyphosphate, phosphorus heterocyclic compounds, etc.

Examples of inorganic phosphorous-containing flame retardants include, but are not limited to red phosphorus, zinc phosphate, ammonium phosphate, ammonium pyrophosphate, and ammonium polyphosphate.

Examples of the organic phosphorus-based flame retardant include, but are not limited to ethylene-diamine phosphate, piperazine phosphate, piperazine pyrophosphate, metal dialkylphosphinate or the combination of metal dialkylphosphinate and metal salt of phosphorous acid.

Examples of the preferred phosphorus-containing flame retardants include, but are not limited to, metal phosphinates derived from phosphinic acid, for example, metal salts of phosphinic acid with Mg, Ca, Al or Zn as the metal. Particular preference is given here to aluminum phosphinate.

Phosphinic acid salts of Formula (VI) and/or diphosphinic acid salts of Formula (VII) or polymers thereof are suitable as component (C) in the polyamide composition according to the present invention:

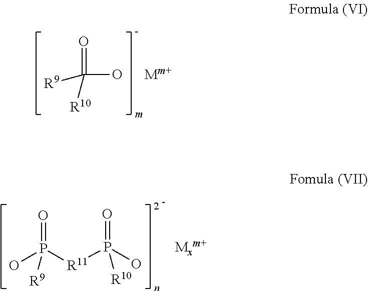

in which
R⁹ and R¹⁰ are independently represent hydrogen, linear or branched C₁-C₆-alkyl, or aryl;
R¹¹ represents linear or branched C₁-C₁₀-alkylene, C₆-C₁₀-arylene, C₆-C₁₀-alkylarylene or C₆-C₁₀-arylalkylene;
M represents Mg, Ca, Al, Sb, Sn, Ge, Ti, Zn, Fe, Zr, Ce, Bi, Sr, Mn, Li, Na, K and/or a protonated nitrogen base;
m=1 to 4; n=1 to 4; x=1 to 4.

Preferably, R⁹ and R¹⁰ independently represent hydrogen, methyl, ethyl, n-propyl, isopropyl, n-butyl, tert-butyl, n-pentyl or phenyl.

Preferably, R¹¹ represents methylene, ethylene, n-propylene, isopropylene, n-butylene, tert-butylene, n-pentylene, n-octylene or n-dodecylene, phenylene or naphthylene; methylphenylene, ethylphenylene, tert-butylphenylene, methylnaphthylene, ethylnaphthylene or tert-butylnaphthylene; phenylmethylene, phenylethylene, phenylpropylene or phenylbutylene.

Particularly preferably, R⁹ and R¹⁰ independently represent hydrogen, methyl, ethyl and M is Al. Aluminum salt of phosphinic acid is particularly preferred, such as aluminum salt of diethyl-phosphinic acid, i.e., aluminum diethylphosphinate (DEPAL), such as Exolit OP1230 from Clariant plastics & Coating Ltd.

For a description of phosphinic acid salts or diphosphinic acid salts, reference can be made to DE-A 199 60 671, DE-A 44 30 932 and DE-A 199 33 901.

The metal dialkylphosphinate can be aluminum dimethylphosphinate, aluminum ethylmethylphosphinate, aluminum diethylphosphinate, aluminum methyl-n-propylphosphinate, calcium dimethylphosphinate, magnesium dimethylphosphinate, zinc dimethylphosphinate, calcium ethylmethylphosphinate, magnesium ethylmethylphosphinate, zinc ethylmethylphosphinate, calcium diethylphoshinate, magnesium diethylphosphinate, zinc diethylphosphinate, calcium methyl-n-propylphosphinate, magnesium methyl-n-propylphosphinate, and/or zinc methyl-n-propylphosphinate. Among them, aluminum diethylphosphinate, zinc diethylphosphinate, aluminum dimethylphosphinate and zinc dimethylphosphinate are more preferable.

The metal salt of phosphorous acid has the following formula

[HP(═O)O₂]²⁻M_{2/m}^{m+}

in which
M is Mg, Ca, Al, Sb, Sn, Ge, Ti, Zn, Fe, Zr, Ce, Bi, Sr, Mn, Li, Na and/or K; and m is 1 to 4,

Preferably, the metal salt of phosphorous acid can be Al(H₂PO₃)₃, Al₂ (HPO₃)₃, Zn(HPO₃), Al₂ (HPO₃)₃·4H₂O and/or Al(OH) (H₂PO₃)₂·2H₂O.

In a preferred embodiment, the suitable organic phosphorus-based flame retardant can be the combination of the metal dialkylphosphinate and the metal salt of phosphorous acid, and can be commercially available as Exolit OP1400 from Clariant plastics & Coating Ltd.

The halogen-containing flame retardants include, but are not limited to, organic chlorides and organic bromides. Suitable halogen-containing flame retardants are preferably brominated compounds, such as brominated diphenyl ether, brominated trimethylphenylindane, tetrabromobisphenol A, hexabromocyclododecane, ring-brominated polystyrene, halogenated polyacrylate such as brominated polybenzyl acrylates, brominated bisphenol A epoxide oligomers and brominated bisphenol A polycarbonates.

Examples of the brominated compounds include oligomeric reaction products (n>3) of tetrabromobisphenol A with epoxides (e.g., FR 2300 and 2400 from DSB) having the following structural formula:

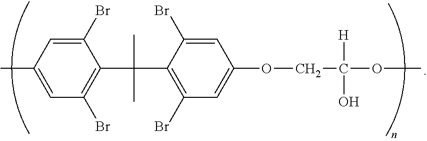

Further examples of the brominated compounds include brominated oligostyrenes, which have an average degree of polymerization (number-average) between 3 and 90, preferably between 5 and 60, measured by vapor pressure osmometry in toluene. The brominated polystyrenes are typically obtained by the process described in EP-A 047 549.

Suitable brominated compounds also include brominated oligocarbonates (BC 52 or BC 58 from Great Lakes) having the following structural formula:

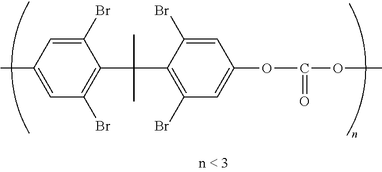

Especially suitable brominated compounds include polypentabromobenzyl acrylates where n>4 having the following structural formula (e.g., FR-1025 from ICL):

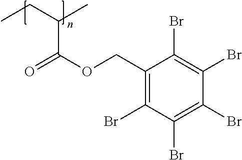

Examples of the nitrogen-containing flame retardants include, but are not limited to, melamine, melam, melem, melon, ammeline, ammelide, 2-ureidomelamine, acetoguanamine, benzoguanamine, diaminophenyltriazine, melamine borate, melamine oxalate, melamine phosphate, melamine sulfate, melamine pyrophosphate, melamine sulfate, melamine neopentyl glycol borate, triazine, triazine derivatives, guanidine, guanidine derivatives, biuret, triuret, tartrazine, glycoluril, acetoguanamine, butyroguanamine, caprinoguanamine, melamine derivatives of cyanuric acid, melamine derivatives of isocyanuric acid, condensation products of melamine, pyrophosphates of condensation products of melamine, dimelamine phosphate, dimelamine pyrophosphate, melamine polyphosphate, dicyandiamide, ammonium mono- or polyphosphate, ammonium hydrogen phosphate, ammonium dihydrogen phosphate, polyphosphates of the condensation products of melamine, allantoin, or mixtures thereof.

The flame retardants can be used alone or in a mixture of flame retardants in the polyamide composition according to the present invention.

It is preferred that the component (C) is present in the polyamide composition according to the present invention in an amount of 10 to 25% by weight of flame retardant, preferably 15 to 20% by weight of flame retardant, based on the total weight of the polyamide composition.

### Component (D)

Flame retardant synergists play a synergistic role in the entire flame retardant system and improve the flame retardant effects. Generally, the amount of flame retardant synergist added is less than that of the flame retardant in the polyamide composition, in order to reduce the amount used of the flame retardants and improve the flame retardant effects.

Examples of the flame retardant synergists used in the polyamide composition according to the present invention include, but are not limited to, melamine cyanurate, antimony trioxide, aluminum hydroxide such as synthetic aluminum metahydroxide (synthetic aluminum hydroxide), natural aluminum metahydroxide (natural aluminum hydroxide), magnesium hydroxide, zinc borate, polysiloxane, alumina, calcium borate, calcium carbonate, calcium magnesium carbonate, calcium oxide, calcium sulfide, iron oxide, magnesium borate, magnesium carbonate, magnesium nitride, magnesium oxide, magnesium sulfide, manganese hydroxide, manganese oxide, titanium nitride, titanium dioxide, zinc metaborate, zinc carbonate, zinc hydroxide, zinc nitrate, zinc oxide, zinc phosphate, zinc sulfide, zinc stannate, zinc hydroxystannate, base zinc silicate, tin oxide hydrate, or any combinations thereof.

Any flame retardant synergists prepared via known processes or any commercially available flame retardant synergists can be used for the purpose of the present invention. Examples of commercially available flame retardant synergists include, but are not limited to, BUDIT 315 E from Budenheim Iberica, S.L., and GM-F01 from Gredmann Fine Chemical Ltd.

It is preferred that the component (D) is present in the polyamide composition according to the present invention in an amount of 1 to 9% by weight of flame retardant synergist, preferably 3 to 8% by weight of flame retardant synergist, more preferably 5 to 7% by weight of flame retardant synergist, based on the total weight of the polyamide composition.

### Component (E)

The polyamide composition according to the present invention can optionally comprise at least one additive as the component (E), for example, lubricants, antioxidants, colorants such as dyes and/or pigments, release agents, reinforcing agents such as glass fibers, impact modifiers, compatibilizing agents, thermostabilizers, photostabilizers such as UV stabilizers, plasticizers, surfactants, nucleating agents, coupling agents, antimicrobial agents, antistatic agents, and any combinations thereof.

For the purpose of the present invention, the additives can be used in conventional amounts. For example, the polyamide composition can comprise at least one additive in an amount of 0.01 to 15% by weight, based on the total weight of the polyamide composition.

The polyamide composition can for example comprise an antioxidant. Suitable antioxidants are aromatic amine-based antioxidants, hindered phenol-based antioxidants and phosphite-based antioxidants, particularly hindered phenol-based antioxidants. Examples of hindered phenol-based antioxidants include, but are not limited to, α-[3-[3,5-bis(1,1-dimethylethyl)-4-hydroxyphenyl]-1-oxopropyl]-w-[3-[3,5-bis(1,1-dimethylethyl)-4-hydroxyphenyl]-1-oxopropoxy]poly(oxy-1,2-ethanediyl), 2,4-bis [(octylthio)methyl]-o-cresol, octyl-3,5-di-tert-butyl-4-hydroxy-hydrocinnamate, 3,5-bis(1,1-dimethylethyl)-4-hydroxybenzenepropanoic acid C7-C9-branched alkyl ester, 2,4-bis [(dodecylthio)methyl]-o-cresol, 4,4′-butylidene bis-(3-methyl-6-tert-butylphenol), 3,5-bis(1,1-dimethylethyl)-4-hydroxybenzenepropanoic acid octadecyl ester, pentaerythritol tetrakis(3-(3,5-di-tert-butyl-4-hydroxyphenyl) propionate), triethylene glycol bis [3-(3-tert-butyl-5-methyl-4-hydrophenyl) propionate], 2,4-bis(n-octylthio)-6-(4-hydroxy-3,5-di-tert-butylanilino)-1,3,5-triazine, tris-(3,5-di-tert-butyl-4-hydroxybenzyl) isocyanurate, 2,2-thiodiethylene bis [3-(3,5-di-tert-butyl-4-hydroxyphenyl) propionate], N,N′-1,6-hexanediylbis [3,5-bis(1,1-dimethylethyl)-4-hydroxyl-benzenepropanamide.

The antioxidant, when present, can be in an amount of 0.01 to 1% by weight, or 0.1 to 0.5% by weight, based on the total weight of the polyamide composition.

The polyamide composition can for example comprise a lubricant. Suitable lubricant is preferably esters or amides of saturated or unsaturated aliphatic carboxylic acids having from 10 to 40, preferably from 16 to 22 carbon atoms with saturated aliphatic alcohols or amines which comprise from 2 to 40, preferably from 2 to 6 carbon atoms.

The carboxylic acids can be mono- or dibasic. Examples of the carboxylic acids are pelargonic acid, palmitic acid, lauric acid, margaric acid, dodecanedioic acid, behenic acid, and particularly preferably stearic acid, capric acid, and also montanic acid (a mixture of fatty acids having from 30 to 40 carbon atoms).

The aliphatic alcohols can be mono-to tetrahydric. Examples of the aliphatic alcohols are n-butanol, n-octanol, stearyl alcohol, ethylene glycol, propylene glycol, neopentyl glycol, and pentaerythritol, preference being given to glycerol and pentaerythritol.

The aliphatic amines can be mono-to trifunctional. Examples of the aliphatic amines are stearylamine, ethylenediamine, propylenediamine, hexamethylenediamine, and di(6-aminohexyl)amine, particular preference being given here to ethylenediamine and hexamethylenediamine.

Preferred esters or amides are N, N′-ethylenedi (stearamide), glycerol distearate, glycerol tristearate, glycerol monopalmitate, glycerol trilaurate, glycerol monobehenate, and pentaerythritol tetrastearate. N, N′-ethylenedi (stearamide) is particularly preferred as a lubricant in the polyamide composition according to the present invention.

It is also possible to use mixtures of various esters or amides, or esters with amides in combination, in any desired mixing ratio.

The other lubricants are preferably long-chain fatty acids (e.g., stearic acid or behenic acid), salts of these (e.g., Ca stearate or Zn stearate), or montan waxes (mixtures of straight-chain, saturated carboxylic acids having chain lengths of from 28 to 32 carbon atoms), Ca montanate or Na montanate, and also low-molecular-weight polyethylene waxes and low-molecular-weight polypropylene waxes.

The lubricant, when present, can be in an amount of 0.01 to 2% by weight, or 0.2 to 1% by weight, based on the total weight of the polyamide composition.

The polyamide composition can for example comprise a colorant which can be inorganic pigments (e.g., TiO₂, SnO₂, ZnO, ZnS, SiO₂, etc.) and organic pigments, and also dyes, for example nigrosin and anthraquinones. For example, EP 1722984 B1, EP 1353986 B1, or DE 10054859 A1 mention suitable colorants.

The colorants, when present, can be in an amount of 0.01 to 15% by weight, or 1 to 15% by weight, or 2 to 8% by weight, based on the total weight of the polyamide composition.

The polyamide composition can for example comprise an impact modifier. Suitable impact modifiers can include polyolefin-based, styrene-based, unsaturated carboxylic acid-based impact modifiers. Suitable impact modifiers can also be those modified by a functional block, such as epoxy functional block and/or acid anhydride block. The epoxy function block can be units derived from a glycidyl (meth)acrylate. The acid anhydride block can be units derived from maleic anhydride.

Suitable polyolefin-based impact modifiers can include polyolefins comprising repeating units derived from olefin having 2 to 10 carbon atoms. Examples of such olefins include ethylene, 1-butene, 1-propylene, 1-pentene, 1-octene and mixture of ethylene and 1-octene, preferably ethylene, 1-propylene and mixture of ethylene and 1-octene.

Suitable unsaturated carboxylic acid-based impact modifiers can include blocks derived from carboxylic acid and derivates thereof such as ester, imide and amide. Suitable carboxylic acid and derivates thereof are for example acrylic acid, acrylic acid, methacrylic acid, maleic acid, fumaric acid, glutaconic acid, itaconic acid, citraconic acid, (meth)acrylate, methyl (meth)acrylate, ethyl (meth)acrylate, propyl (meth)acrylate, butyl(methyl) acrylate and isobutyl (meth)acrylate.

The impact modifier can also be a bi- or ter-polymer or a core-shell structure polymer. Examples of such impact modifier include styrene/ethylene/butylene copolymer (SEBS), ethylene-methyl acrylate-glycidyl methacrylate terpolymer, ethylene/propylene/diene rubber (EPDM) and ethylene-octene copolymer.

The impact modifier, when present, can be in an amount of 0.01 to 15% by weight, or 1 to 15% by weight, or 5 to 10% by weight, based on the total weight of the polyamide composition.

The polyamide composition can for example a plasticizer, including but are not limited to dioctyl phthalate, dibenzyl phthalate, butyl benzyl phthalate, hydrocarbon oils, and N-(n-butyl)benzenesulfonamide.

The plasticizer, when present, can be in an amount of 0.01 to 15% by weight, or 1 to 15% by weight, or 5 to 10% by weight, based on the total weight of the polyamide composition.

In a particular embodiment according to the present invention, the polyamide composition comprises:
(A) 15 to 50% by weight of a polyamide,
(B) 20 to 55% by weight of a polyketone,
(C) 10 to 25% by weight of a flame retardant, and
(D) 3 to 8% by weight of a flame retardant synergist, each being based on the total weight of the polyamide composition, wherein the polyamide has at least one type of structural units of 8 or more carbon atoms.

In one preferred embodiment, the polyamide composition comprises:
(A) 15 to 50% by weight of a polyamide,
(B) 20 to 55% by weight of a polyketone,
(C) 10 to 25% by weight of a flame retardant, and
(D) 3 to 8% by weight of a flame retardant synergist, each being based on the total weight of the polyamide composition, wherein the polyamide has at least one type of structural units of 10 or more carbon atoms.

In another preferred embodiment, the polyamide composition comprises:
(A) 15 to 50% by weight of a polyamide,
(B) 20 to 55% by weight of a polyketone,
(C) 10 to 25% by weight of a flame retardant, and
(D) 3 to 8% by weight of a flame retardant synergist, each being based on the total weight of the polyamide composition, wherein the polyamide is selected from the group consisting of a polyamide having repeating units of Formula (I), a polyamide having repeating units of Formula (II), and any combinations thereof:

[symbol]

NH—R¹—CO [symbol] Formula (I),

wherein
R¹ is a hydrocarbylene group having from 6 to 40 carbon atoms, preferably from 8 to 19 carbon atoms, more preferably from 8 to 12 carbon atoms;

[symbol]

NH—R²—NH—CO—R³—CO [symbol] Formula (II),

wherein
R² is a hydrocarbylene group having from 4 to 40 carbon atoms, preferably from 4 to 24 carbon atoms, more preferably from 4 to 18, most preferably from 4 to 14 carbon atoms, R³ is a hydrocarbylene group having from 4 to 40 carbon atoms, preferably from 7 to 36 carbon atoms, more preferably from 8 to 20 carbon atoms, and wherein R² has more than 6 carbon atoms and/or R³ has more than 4 carbon atoms.

In further preferred embodiment, the polyamide composition comprises:
(A) 15 to 50% by weight of a polyamide,
(B) 20 to 55% by weight of a polyketone,
(C) 10 to 25% by weight of a flame retardant, and
(D) 3 to 8% by weight of a flame retardant synergist,
   each being based on the total weight of the polyamide composition,
   wherein the polyamide is selected from the group consisting of PA410, PA510, PA513, PA515, PA69, PA610, PA612, PA613, PA614, PA618, PA636, PA88, PA810, PA812, PA1010, PA1012, PA1014, PA1018, PA1210, PA1212, PA1214, PA1218, PA1313, PA1410, PA1412, PA1414, PA1418, and any combinations thereof, preferably PA410, PA510, PA610, PA612, PA618, PA1010, PA1012, PA1210, PA1212, and any combinations thereof, more preferably PA510, PA1010, and any combinations thereof.

In another preferred embodiment, the polyamide composition comprises:
(A) 15 to 50% by weight of a polyamide,
(B) 20 to 55% by weight of a polyketone,
(C) 10 to 25% by weight of a flame retardant, and
(D) 3 to 8% by weight of a flame retardant synergist,
   each being based on the total weight of the polyamide composition,
   wherein the polyamide is selected from the group consisting of a polyamide having repeating units of Formula (I), a polyamide having repeating units of Formula (II), and any combinations thereof:

[symbol]

NH—R¹—CO [symbol] Formula (I),

wherein
R¹ is a hydrocarbylene group having from 6 to 40 carbon atoms, preferably from 8 to 19 carbon atoms, more preferably from 8 to 12 carbon atoms;

[symbol]

NH—R²—NH—CO—R³—CO [symbol] Formula (II),

wherein
R² is a hydrocarbylene group having from 4 to 40 carbon atoms, preferably from 4 to 24 carbon atoms, more preferably from 4 to 18, most preferably from 4 to 14 carbon atoms,
R³ is a hydrocarbylene group having from 4 to 40 carbon atoms, preferably from 7 to 36 carbon atoms, more preferably from 8 to 20 carbon atoms, and
   wherein R² has more than 6 carbon atoms and/or R³ has more than 4 carbon atoms, and wherein the polyketone has repeating units of Formula (V):

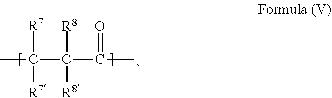

wherein R⁷, R^{7′}, R⁸ and R^{8′} are each independently hydrogen or hydrocarbyl groups having 1 to 20 carbon atoms, preferably 1 to 10 carbon atoms, and wherein the polyketone has a number average molecular weight (Mn) of less than 70,000, for example in the range from 10,000 to 70,000, 30,000 to 70,000, or 45,000 to 65,000.

In further preferred embodiment, the polyamide composition comprises:
(A) 15 to 50% by weight of a polyamide,
(B) 20 to 55% by weight of a polyketone,
(C) 10 to 25% by weight of a flame retardant, and
(D) 3 to 8% by weight of a flame retardant synergist,
   each being based on the total weight of the polyamide composition,
   wherein the polyamide is selected from the group consisting of PA410, PA510, PA513, PA515, PA69, PA610, PA612, PA613, PA614, PA618, PA636, PA88, PA810, PA812, PA1010, PA1012, PA1014, PA1018, PA1210, PA1212, PA1214, PA1218, PA1313, PA1410, PA1412, PA1414, PA1418, and any combinations thereof, preferably PA410, PA510, PA610, PA612, PA618, PA1010, PA1012, PA1210, PA1212, and any combinations thereof, more preferably PA510, PA1010, and any combinations thereof, and
   wherein the polyketone has repeating units of Formula (V):

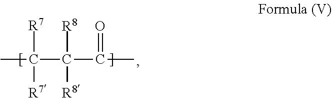

wherein R⁷, R^{7′}, R⁸ and R^{8′} are each independently hydrogen or hydrocarbyl groups having 1 to 20 carbon atoms, preferably 1 to 10 carbon atoms, and wherein the polyketone has a number average molecular weight (Mn) of less than 70,000, for example in the range from 10,000 to 70,000, 30,000 to 70,000, or 45,000 to 65,000.

In another preferred embodiment, the polyamide composition comprises:
(A) 15 to 50% by weight of a polyamide,
(B) 20 to 55% by weight of a polyketone,
(C) 10 to 25% by weight of a flame retardant, and
(D) 3 to 8% by weight of a flame retardant synergist,
   each being based on the total weight of the polyamide composition,
   wherein the polyamide is a polyamide copolymer comprising a repeating unit of Formula (I) and a repeating unit of Formula (II), or two or more types of repeating units of Formula (I), or two or more types of repeating units of Formula (II), and optionally comprising at least one type of repeating units of Formula (III) and/or Formula (IV):

[symbol]

NH—R¹—CO [symbol] Formula (I),

wherein
R¹ is a hydrocarbylene group having from 6 to 40 carbon atoms, preferably from 8 to 19 carbon atoms, more preferably from 8 to 12 carbon atoms;

[symbol]

NH—R²—NH—CO—R³—CO [symbol] Formula (II),

wherein
R² is a hydrocarbylene group having from 4 to 40 carbon atoms, preferably from 4 to 24 carbon atoms, more preferably from 4 to 18, most preferably from 4 to 14 carbon atoms,
R³ is a hydrocarbylene group having from 4 to 40 carbon atoms, preferably from 7 to 36 carbon atoms, more preferably from 8 to 20 carbon atoms, and
   wherein R² has more than 6 carbon atoms and/or R³ has more than 4 carbon atoms,

[symbol]

NH—R⁴—CO [symbol] Formula (III),

wherein,
R⁴ is a hydrocarbylene group having from 2 to 5 carbon atoms, preferably from 3 to 5 carbon atoms;

[symbol]

NH—R⁵—NH—CO—R⁶—CO [symbol] Formula (IV),

wherein
R⁵ is a hydrocarbylene group having from 2 to 6 carbon atoms, and
R⁶ is a hydrocarbylene group having from 1 to 4 carbon atoms.

In one preferred embodiment, the polyamide composition comprises:
(A) 15 to 50% by weight of a polyamide,
(B) 20 to 55% by weight of a polyketone,
(C) 10 to 25% by weight of a flame retardant, and
(D) 3 to 8% by weight of a flame retardant synergist,
   each being based on the total weight of the polyamide composition,
   wherein the polyamide is selected from the group consisting of a polyamide having repeating units of Formula (I), a polyamide having repeating units of Formula (II), and any combinations thereof:

[symbol]

NH—R¹—CO [symbol] Formula (I),

wherein
R¹ is a hydrocarbylene group having from 6 to 40 carbon atoms, preferably from 8 to 19 carbon atoms, more preferably from 8 to 12 carbon atoms;

[symbol]

NH—R²—NH—CO—R³—CO [symbol] Formula (II),

wherein
R² is a hydrocarbylene group having from 4 to 40 carbon atoms, preferably from 4 to 24 carbon atoms, more preferably from 4 to 18, most preferably from 4 to 14 carbon atoms,
R³ is a hydrocarbylene group having from 4 to 40 carbon atoms, preferably from 7 to 36 carbon atoms, more preferably from 8 to 20 carbon atoms, and
   wherein R² has more than 6 carbon atoms and/or R³ has more than 4 carbon atoms, and
   wherein the flame retardant is organic phosphorus-based flame retardant.

In further preferred embodiment, the polyamide composition comprises:
(A) 15 to 50% by weight of a polyamide,
(B) 20 to 55% by weight of a polyketone,
(C) 10 to 25% by weight of a flame retardant, and
(D) 3 to 8% by weight of a flame retardant synergist,
   each being based on the total weight of the polyamide composition,
   wherein the polyamide is selected from the group consisting of a polyamide having repeating units of Formula (I), a polyamide having repeating units of Formula (II), and any combinations thereof:

[symbol]

NH—R¹—CO [symbol] Formula (I),

wherein
R¹ is a hydrocarbylene group having from 6 to 40 carbon atoms, preferably from 8 to 19 carbon atoms, more preferably from 8 to 12 carbon atoms;

[symbol]

NH—R²—NH—CO—R³—CO [symbol] Formula (II),

wherein
R² is a hydrocarbylene group having from 4 to 40 carbon atoms, preferably from 4 to 24 carbon atoms, more preferably from 4 to 18, most preferably from 4 to 14 carbon atoms,
R³ is a hydrocarbylene group having from 4 to 40 carbon atoms, preferably from 7 to 36 carbon atoms, more preferably from 8 to 20 carbon atoms, and
   wherein R² has more than 6 carbon atoms and/or R³ has more than 4 carbon atoms, and
   wherein the flame retardant is ethylene-diamine phosphate, piperazine phosphate, piperazine pyrophosphate, metal dialkylphosphinate or the combination of metal dialkylphosphinate and metal salt of phosphorous acid.

In further preferred embodiment, the polyamide composition comprises:
(A) 15 to 50% by weight of a polyamide,
(B) 20 to 55% by weight of a polyketone,
(C) 10 to 25% by weight of a flame retardant, and
(D) 3 to 8% by weight of a flame retardant synergist,
   each being based on the total weight of the polyamide composition,
   wherein the polyamide is selected from the group consisting of a polyamide having repeating units of Formula (I), a polyamide having repeating units of Formula (II), and any combinations thereof:

[symbol]

NH—R¹—CO [symbol] Formula (I),

wherein
R¹ is a hydrocarbylene group having from 6 to 40 carbon atoms, preferably from 8 to 19 carbon atoms, more preferably from 8 to 12 carbon atoms;

[symbol]

NH—R²—NH—CO—R³—CO [symbol] Formula (II),

wherein
R² is a hydrocarbylene group having from 4 to 40 carbon atoms, preferably from 4 to 24 carbon atoms, more preferably from 4 to 18, most preferably from 4 to 14 carbon atoms,
R³ is a hydrocarbylene group having from 4 to 40 carbon atoms, preferably from 7 to 36 carbon atoms, more preferably from 8 to 20 carbon atoms, and
   wherein R² has more than 6 carbon atoms and/or R³ has more than 4 carbon atoms, and
   wherein the flame retardant is an aluminum dialkylphosphinate, and wherein the alkyl contains 1-20 carbon atoms, preferably 2-8 carbon atoms.

In further preferred embodiment, the polyamide composition comprises:
(A) 15 to 50% by weight of a polyamide,
(B) 20 to 55% by weight of a polyketone,
(C) 10 to 25% by weight of a flame retardant, and
(D) 3 to 8% by weight of a flame retardant synergist,
   each being based on the total weight of the polyamide composition,
   wherein the polyamide is selected from the group consisting of a polyamide having repeating units of Formula (I), a polyamide having repeating units of Formula (II), and any combinations thereof:

[symbol]

NH—R¹—CO [symbol] Formula (I),

wherein
R¹ is a hydrocarbylene group having from 6 to 40 carbon atoms, preferably from 8 to 19 carbon atoms, more preferably from 8 to 12 carbon atoms;

[symbol]

NH—R²—NH—CO—R³—CO [symbol] Formula (II),

wherein
R² is a hydrocarbylene group having from 4 to 40 carbon atoms, preferably from 4 to 24 carbon atoms, more preferably from 4 to 18, most preferably from 4 to 14 carbon atoms,
R³ is a hydrocarbylene group having from 4 to 40 carbon atoms, preferably from 7 to 36 carbon atoms, more preferably from 8 to 20 carbon atoms, and
   wherein R² has more than 6 carbon atoms and/or R³ has more than 4 carbon atoms, and
   wherein the flame retardant is an aluminum diethylphosphinate.

In another preferred embodiment, the polyamide composition comprises:
(A) 15 to 50% by weight of a polyamide,
(B) 20 to 55% by weight of a polyketone,
(C) 10 to 25% by weight of a flame retardant, and
(D) 3 to 8% by weight of a flame retardant synergist,
   each being based on the total weight of the polyamide composition,
   wherein the polyamide is selected from the group consisting of a polyamide having repeating units of Formula (I), a polyamide having repeating units of Formula (II), and any combinations thereof:

[symbol]

NH—R¹—CO [symbol] Formula (I),

wherein
R¹ is a hydrocarbylene group having from 6 to 40 carbon atoms, preferably from 8 to 19 carbon atoms, more preferably from 8 to 12 carbon atoms;

[symbol]

NH—R²—NH—CO—R³—CO [symbol] Formula (II),

wherein
R² is a hydrocarbylene group having from 4 to 40 carbon atoms, preferably from 4 to 24 carbon atoms, more preferably from 4 to 18, most preferably from 4 to 14 carbon atoms,
R³ is a hydrocarbylene group having from 4 to 40 carbon atoms, preferably from 7 to 36 carbon atoms, more preferably from 8 to 20 carbon atoms, and
   wherein R² has more than 6 carbon atoms and/or R³ has more than 4 carbon atoms, and
   wherein the flame retardant is the combination of aluminum dialkylphosphinate and aluminum salt of phosphorous acid, and wherein the alkyl contains 1-20 carbon atoms, preferably 2-8 carbon atoms.

In further preferred embodiment, the polyamide composition comprises:
(A) 15 to 50% by weight of a polyamide,
(B) 20 to 55% by weight of a polyketone,
(C) 10 to 25% by weight of a flame retardant, and
(D) 3 to 8% by weight of a flame retardant synergist,
   each being based on the total weight of the polyamide composition,
   wherein the polyamide is selected from the group consisting of a polyamide having repeating units of Formula (I), a polyamide having repeating units of Formula (II), and any combinations thereof:

[symbol]

NH—R¹—CO [symbol] Formula (I),

wherein
R¹ is a hydrocarbylene group having from 6 to 40 carbon atoms, preferably from 8 to 19 carbon atoms, more preferably from 8 to 12 carbon atoms;

[symbol]

NH—R²—NH—CO—R³—CO [symbol] Formula (II),

wherein
R² is a hydrocarbylene group having from 4 to 40 carbon atoms, preferably from 4 to 24 carbon atoms, more preferably from 4 to 18, most preferably from 4 to 14 carbon atoms,
R³ is a hydrocarbylene group having from 4 to 40 carbon atoms, preferably from 7 to 36 carbon atoms, more preferably from 8 to 20 carbon atoms, and
   wherein R² has more than 6 carbon atoms and/or R³ has more than 4 carbon atoms, and
   wherein the flame retardant is the combination of aluminum diethylphosphinate and aluminum salt of phosphorous acid.

In one preferred embodiment, the polyamide composition comprises:
(A) 15 to 50% by weight of a polyamide,
(B) 20 to 55% by weight of a polyketone,
(C) 10 to 25% by weight of a flame retardant, and
(D) 3 to 8% by weight of a flame retardant synergist,
   each being based on the total weight of the polyamide composition,
   wherein the polyamide is selected from the group consisting of a polyamide having repeating units of Formula (I), a polyamide having repeating units of Formula (II), and any combinations thereof:

[symbol]

NH—R¹—CO [symbol] Formula (I),

wherein
R¹ is a hydrocarbylene group having from 6 to 40 carbon atoms, preferably from 8 to 19 carbon atoms, more preferably from 8 to 12 carbon atoms;

[symbol]

NH—R²—NH—CO—R³—CO [symbol] Formula (II),

wherein
R² is a hydrocarbylene group having from 4 to 40 carbon atoms, preferably from 4 to 24 carbon atoms, more preferably from 4 to 18, most preferably from 4 to 14 carbon atoms,
R³ is a hydrocarbylene group having from 4 to 40 carbon atoms, preferably from 7 to 36 carbon atoms, more preferably from 8 to 20 carbon atoms, and
   wherein R² has more than 6 carbon atoms and/or R³ has more than 4 carbon atoms,
   wherein the flame retardant is organic phosphorus-based flame retardant, and
   wherein the flame retardant synergist is a halogen-containing flame retardant synergist.

In another preferred embodiment, the polyamide composition comprises:
(A) 15 to 50% by weight of a polyamide,
(B) 20 to 55% by weight of a polyketone,
(C) 10 to 25% by weight of a flame retardant, and
(D) 3 to 8% by weight of a flame retardant synergist,
   each being based on the total weight of the polyamide composition,
   wherein the polyamide is selected from the group consisting of a polyamide having repeating units of Formula (I), a polyamide having repeating units of Formula (II), and any combinations thereof:

[symbol]

NH—R¹—CO [symbol] Formula (I),

wherein
R¹ is a hydrocarbylene group having from 6 to 40 carbon atoms, preferably from 8 to 19 carbon atoms, more preferably from 8 to 12 carbon atoms;

[symbol]

NH—R²—NH—CO—R³—CO [symbol] Formula (II),

wherein
R² is a hydrocarbylene group having from 4 to 40 carbon atoms, preferably from 4 to 24 carbon atoms, more preferably from 4 to 18, most preferably from 4 to 14 carbon atoms,
R³ is a hydrocarbylene group having from 4 to 40 carbon atoms, preferably from 7 to 36 carbon atoms, more preferably from 8 to 20 carbon atoms, and
   wherein R² has more than 6 carbon atoms and/or R³ has more than 4 carbon atoms,
   wherein the polyketone has repeating units of Formula (V):

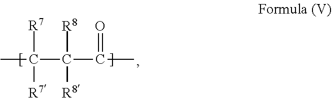

wherein R⁷, R^{7′}, R⁸ and R^{8′} are each independently hydrogen or hydrocarbyl groups having 1 to 20 carbon atoms, preferably 1 to 10 carbon atoms, and wherein the polyketone has a number average molecular weight (Mn) of less than 70,000, for example in the range from 10,000 to 70,000, 30,000 to 70,000, or 45,000 to 65,000,
wherein the flame retardant is organic phosphorus-based flame retardant, and
wherein the flame retardant synergist is a halogen-containing flame retardant synergist.

In further preferred embodiment, the polyamide composition comprises:
(A) 15 to 50% by weight of a polyamide,
(B) 20 to 55% by weight of a polyketone,
(C) 10 to 25% by weight of a flame retardant, and
(D) 3 to 8% by weight of a flame retardant synergist,
   each being based on the total weight of the polyamide composition,
   wherein the polyamide is selected from the group consisting of a polyamide having repeating units of Formula (I), a polyamide having repeating units of Formula (II), and any combinations thereof:

[symbol]

NH—R¹—CO [symbol] Formula (I),

wherein
R¹ is a hydrocarbylene group having from 6 to 40 carbon atoms, preferably from 8 to 19 carbon atoms, more preferably from 8 to 12 carbon atoms;

[symbol]

NH—R²—NH—CO—R³—CO [symbol] Formula (II),

wherein
R² is a hydrocarbylene group having from 4 to 40 carbon atoms, preferably from 4 to 24 carbon atoms, more preferably from 4 to 18, most preferably from 4 to 14 carbon atoms,
R³ is a hydrocarbylene group having from 4 to 40 carbon atoms, preferably from 7 to 36 carbon atoms, more preferably from 8 to 20 carbon atoms, and
   wherein R² has more than 6 carbon atoms and/or R³ has more than 4 carbon atoms,
   wherein the polyketone has repeating units of Formula (V):

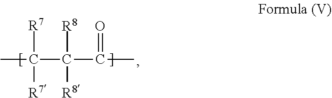

wherein R⁷, R^{7′}, R⁸ and R^{8′} are each independently hydrogen or hydrocarbyl groups having 1 to 20 carbon atoms, preferably 1 to 10 carbon atoms, and wherein the polyketone has a number average molecular weight (Mn) of less than 70,000, for example in the range from 10,000 to 70,000, 30,000 to 70,000, or 45,000 to 65,000,
wherein the flame retardant is metal dialkylphosphinate, and
wherein the flame retardant synergist is a halogen-containing flame retardant synergist.

In another particular embodiment according to the present invention, the polyamide composition comprises:
(A) 20 to 45% by weight of a polyamide,
(B) 25 to 50% by weight of a polyketone,
(C) 15 to 20% by weight of a flame retardant, and
(D) 5 to 7% by weight of a flame retardant synergist,
   each being based on the total weight of the polyamide composition,
   wherein the polyamide has at least one type of structural units of 8 or more carbon atoms.

In one preferred embodiment, the polyamide composition comprises:
(A) 20 to 45% by weight of a polyamide,
(B) 25 to 50% by weight of a polyketone,
(C) 15 to 20% by weight of a flame retardant, and
(D) 5 to 7% by weight of a flame retardant synergist,
   each being based on the total weight of the polyamide composition,
   wherein the polyamide has at least one type of structural units of 10 or more carbon atoms.

In another preferred embodiment, the polyamide composition comprises:
(A) 20 to 45% by weight of a polyamide,
(B) 25 to 50% by weight of a polyketone,
(C) 15 to 20% by weight of a flame retardant, and
(D) 5 to 7% by weight of a flame retardant synergist,
   each being based on the total weight of the polyamide composition,
   wherein the polyamide is selected from the group consisting of a polyamide having repeating units of Formula (I), a polyamide having repeating units of Formula (II), and any combinations thereof:

[symbol]

NH—R¹—CO [symbol] Formula (I),

wherein
R¹ is a hydrocarbylene group having from 6 to 40 carbon atoms, preferably from 8 to 19 carbon atoms, more preferably from 8 to 12 carbon atoms;

[symbol]

NH—R²—NH—CO—R³—CO [symbol] Formula (II),

wherein
R² is a hydrocarbylene group having from 4 to 40 carbon atoms, preferably from 4 to 24 carbon atoms, more preferably from 4 to 18, most preferably from 4 to 14 carbon atoms,
R³ is a hydrocarbylene group having from 4 to 40 carbon atoms, preferably from 7 to 36 carbon atoms, more preferably from 8 to 20 carbon atoms, and wherein R² has more than 6 carbon atoms and/or R³ has more than 4 carbon atoms.

In further preferred embodiment, the polyamide composition comprises:
(A) 20 to 45% by weight of a polyamide,
(B) 25 to 50% by weight of a polyketone,
(C) 15 to 20% by weight of a flame retardant, and
(D) 5 to 7% by weight of a flame retardant synergist,
   each being based on the total weight of the polyamide composition,
   wherein the polyamide is selected from the group consisting of PA410, PA510, PA513, PA515, PA69, PA610, PA612, PA613, PA614, PA618, PA636, PA88, PA810, PA812, PA1010, PA1012, PA1014, PA1018, PA1210, PA1212, PA1214, PA1218, PA1313, PA1410, PA1412, PA1414, PA1418, and any combinations thereof, preferably PA410, PA510, PA610, PA612, PA618, PA1010, PA1012, PA1210, PA1212, and any combinations thereof, more preferably PA510, PA1010, and any combinations thereof.

In further preferred embodiment, the polyamide composition comprises:
(A) 20 to 45% by weight of a polyamide,
(B) 25 to 50% by weight of a polyketone,
(C) 15 to 20% by weight of a flame retardant, and
(D) 5 to 7% by weight of a flame retardant synergist,
   each being based on the total weight of the polyamide composition,
   wherein the polyamide is selected from the group consisting of a polyamide having repeating units of Formula (I), a polyamide having repeating units of Formula (II), and any combinations thereof:

[symbol]

NH—R¹—CO [symbol] Formula (I),

wherein
R¹ is a hydrocarbylene group having from 6 to 40 carbon atoms, preferably from 8 to 19 carbon atoms, more preferably from 8 to 12 carbon atoms;

[symbol]

NH—R²—NH—CO—R³—CO [symbol] Formula (II),

wherein
R² is a hydrocarbylene group having from 4 to 40 carbon atoms, preferably from 4 to 24 carbon atoms, more preferably from 4 to 18, most preferably from 4 to 14 carbon atoms,
R³ is a hydrocarbylene group having from 4 to 40 carbon atoms, preferably from 7 to 36 carbon atoms, more preferably from 8 to 20 carbon atoms, and
   wherein R² has more than 6 carbon atoms and/or R³ has more than 4 carbon atoms, and
   wherein the polyketone has repeating units of Formula (V):

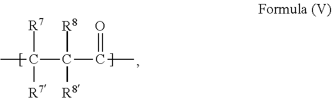

wherein R⁷, R^{7′}, R⁸ and R^{8′} are each independently hydrogen or hydrocarbyl groups having 1 to 20 carbon atoms, preferably 1 to 10 carbon atoms, and wherein the polyketone has a number average molecular weight (Mn) of less than 70,000, for example in the range from 10,000 to 70,000, 30,000 to 70,000, or 45,000 to 65,000.

In further preferred embodiment, the polyamide composition comprises:
(A) 20 to 45% by weight of a polyamide,
(B) 25 to 50% by weight of a polyketone,
(C) 15 to 20% by weight of a flame retardant, and
(D) 5 to 7% by weight of a flame retardant synergist,
   each being based on the total weight of the polyamide composition,
   wherein the polyamide is selected from the group consisting of PA410, PA510, PA513, PA515, PA69, PA610, PA612, PA613, PA614, PA618, PA636, PA88, PA810, PA812, PA1010, PA1012, PA1014, PA1018, PA1210, PA1212, PA1214, PA1218, PA1313, PA1410, PA1412, PA1414, PA1418, and any combinations thereof, preferably PA410, PA510, PA610, PA612, PA618, PA1010, PA1012, PA1210, PA1212, and any combinations thereof, more preferably PA510, PA1010, and any combinations thereof, and
   wherein the polyketone has repeating units of Formula (V):

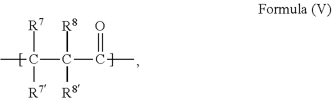

wherein R⁷, R^{7′}, R⁸ and R^{8′} are each independently hydrogen or hydrocarbyl groups having 1 to 20 carbon atoms, preferably 1 to 10 carbon atoms, and wherein the polyketone has a number average molecular weight (Mn) of less than 70,000, for example in the range from 10,000 to 70,000, 30,000 to 70,000, or 45,000 to 65,000.

In another preferred embodiment, the polyamide composition comprises:
(A) 20 to 45% by weight of a polyamide,
(B) 25 to 50% by weight of a polyketone,
(C) 15 to 20% by weight of a flame retardant, and
(D) 5 to 7% by weight of a flame retardant synergist,
   each being based on the total weight of the polyamide composition,
   wherein the polyamide is a polyamide copolymer comprising a repeating unit of Formula (I) and a repeating unit of Formula (II), or two or more types of repeating units of Formula (I), or two or more types of repeating units of Formula (II), and optionally comprising at least one type of repeating units of Formula (III) and/or Formula (IV):

[symbol]

NH—R¹—CO [symbol] Formula (I),

wherein
R¹ is a hydrocarbylene group having from 6 to 40 carbon atoms, preferably from 8 to 19 carbon atoms, more preferably from 8 to 12 carbon atoms;

[symbol]

NH—R²—NH—CO—R³—CO [symbol] Formula (II),

wherein
R² is a hydrocarbylene group having from 4 to 40 carbon atoms, preferably from 4 to 24 carbon atoms, more preferably from 4 to 18, most preferably from 4 to 14 carbon atoms,
R³ is a hydrocarbylene group having from 4 to 40 carbon atoms, preferably from 7 to 36 carbon atoms, more preferably from 8 to 20 carbon atoms, and
   wherein R² has more than 6 carbon atoms and/or R³ has more than 4 carbon atoms,

[symbol]

NH—R⁴—CO [symbol] Formula (III),

wherein,
R⁴ is a hydrocarbylene group having from 2 to 5 carbon atoms, preferably from 3 to 5 carbon atoms;

[symbol]

NH—R⁵—NH—CO—R⁶—CO [symbol] Formula (IV),

wherein
R⁵ is a hydrocarbylene group having from 2 to 6 carbon atoms, and
R⁶ is a hydrocarbylene group having from 1 to 4 carbon atoms.

In one preferred embodiment, the polyamide composition comprises:
(A) 20 to 45% by weight of a polyamide,
(B) 25 to 50% by weight of a polyketone,
(C) 15 to 20% by weight of a flame retardant, and
(D) 5 to 7% by weight of a flame retardant synergist,
   each being based on the total weight of the polyamide composition,
   wherein the polyamide is selected from the group consisting of a polyamide having repeating units of Formula (I), a polyamide having repeating units of Formula (II), and any combinations thereof:

[symbol]

NH—R¹—CO [symbol] Formula (I),

wherein

R¹ is a hydrocarbylene group having from 6 to 40 carbon atoms, preferably from 8 to 19 carbon atoms, more preferably from 8 to 12 carbon atoms;

[symbol]

NH—R²—NH—CO—R³—CO [symbol] Formula (II),

wherein
R² is a hydrocarbylene group having from 4 to 40 carbon atoms, preferably from 4 to 24 carbon atoms, more preferably from 4 to 18, most preferably from 4 to 14 carbon atoms,
R³ is a hydrocarbylene group having from 4 to 40 carbon atoms, preferably from 7 to 36 carbon atoms, more preferably from 8 to 20 carbon atoms, and
   wherein R² has more than 6 carbon atoms and/or R³ has more than 4 carbon atoms, and
   wherein the flame retardant is organic phosphorus-based flame retardant.

In further preferred embodiment, the polyamide composition comprises:
(A) 20 to 45% by weight of a polyamide,
(B) 25 to 50% by weight of a polyketone,
(C) 15 to 20% by weight of a flame retardant, and
(D) 5 to 7% by weight of a flame retardant synergist,
   each being based on the total weight of the polyamide composition,
   wherein the polyamide is selected from the group consisting of a polyamide having repeating units of Formula (I), a polyamide having repeating units of Formula (II), and any combinations thereof:

[symbol]

NH—R¹—CO [symbol] Formula (I),

wherein

R¹ is a hydrocarbylene group having from 6 to 40 carbon atoms, preferably from 8 to 19 carbon atoms, more preferably from 8 to 12 carbon atoms;

[symbol]

NH—R²—NH—CO—R³—CO [symbol] Formula (II),

wherein
R² is a hydrocarbylene group having from 4 to 40 carbon atoms, preferably from 4 to 24 carbon atoms, more preferably from 4 to 18, most preferably from 4 to 14 carbon atoms,
R³ is a hydrocarbylene group having from 4 to 40 carbon atoms, preferably from 7 to 36 carbon atoms, more preferably from 8 to 20 carbon atoms, and
   wherein R² has more than 6 carbon atoms and/or R³ has more than 4 carbon atoms, and
   wherein the flame retardant is ethylene-diamine phosphate, piperazine phosphate, piperazine pyrophosphate, metal dialkylphosphinate or the combination of metal dialkylphosphinate and metal salt of phosphorous acid.

In further preferred embodiment, the polyamide composition comprises:
(A) 20 to 45% by weight of a polyamide,
(B) 25 to 50% by weight of a polyketone,
(C) 15 to 20% by weight of a flame retardant, and
(D) 5 to 7% by weight of a flame retardant synergist,
   each being based on the total weight of the polyamide composition,
   wherein the polyamide is selected from the group consisting of a polyamide having repeating units of Formula (I), a polyamide having repeating units of Formula (II), and any combinations thereof:

[symbol]

NH—R¹—CO [symbol] Formula (I),

wherein
R¹ is a hydrocarbylene group having from 6 to 40 carbon atoms, preferably from 8 to 19 carbon atoms, more preferably from 8 to 12 carbon atoms;

[symbol]

NH—R²—NH—CO—R³—CO [symbol] Formula (II),

wherein
R² is a hydrocarbylene group having from 4 to 40 carbon atoms, preferably from 4 to 24 carbon atoms, more preferably from 4 to 18, most preferably from 4 to 14 carbon atoms,
R³ is a hydrocarbylene group having from 4 to 40 carbon atoms, preferably from 7 to 36 carbon atoms, more preferably from 8 to 20 carbon atoms, and
   wherein R² has more than 6 carbon atoms and/or R³ has more than 4 carbon atoms, and
   wherein the flame retardant is an aluminum dialkylphosphinate, and wherein the alkyl contains 1-20 carbon atoms, preferably 2-8 carbon atoms.

In further preferred embodiment, the polyamide composition comprises:
(A) 20 to 45% by weight of a polyamide,
(B) 25 to 50% by weight of a polyketone,
(C) 15 to 20% by weight of a flame retardant, and
(D) 5 to 7% by weight of a flame retardant synergist,
   each being based on the total weight of the polyamide composition,
   wherein the polyamide is selected from the group consisting of a polyamide having repeating units of Formula (I), a polyamide having repeating units of Formula (II), and any combinations thereof:

[symbol]

NH—R¹—CO [symbol] Formula (I),

wherein
R¹ is a hydrocarbylene group having from 6 to 40 carbon atoms, preferably from 8 to 19 carbon atoms, more preferably from 8 to 12 carbon atoms;

[symbol]

NH—R²—NH—CO—R³—CO [symbol] Formula (II),

wherein
R² is a hydrocarbylene group having from 4 to 40 carbon atoms, preferably from 4 to 24 carbon atoms, more preferably from 4 to 18, most preferably from 4 to 14 carbon atoms,
R³ is a hydrocarbylene group having from 4 to 40 carbon atoms, preferably from 7 to 36 carbon atoms, more preferably from 8 to 20 carbon atoms, and
   wherein R² has more than 6 carbon atoms and/or R³ has more than 4 carbon atoms, and
   wherein the flame retardant is an aluminum diethylphosphinate.

In another preferred embodiment, the polyamide composition comprises:
(A) 20 to 45% by weight of a polyamide,
(B) 25 to 50% by weight of a polyketone,
(C) 15 to 20% by weight of a flame retardant, and
(D) 5 to 7% by weight of a flame retardant synergist,
   each being based on the total weight of the polyamide composition,
   wherein the polyamide is selected from the group consisting of a polyamide having repeating units of Formula (I), a polyamide having repeating units of Formula (II), and any combinations thereof:

[symbol]

NH—R¹—CO [symbol] Formula (I),

wherein
R¹ is a hydrocarbylene group having from 6 to 40 carbon atoms, preferably from 8 to 19 carbon atoms, more preferably from 8 to 12 carbon atoms;

[symbol]

NH—R²—NH—CO—R³—CO [symbol] Formula (II),

wherein
R² is a hydrocarbylene group having from 4 to 40 carbon atoms, preferably from 4 to 24 carbon atoms, more preferably from 4 to 18, most preferably from 4 to 14 carbon atoms,
R³ is a hydrocarbylene group having from 4 to 40 carbon atoms, preferably from 7 to 36 carbon atoms, more preferably from 8 to 20 carbon atoms, and
   wherein R² has more than 6 carbon atoms and/or R³ has more than 4 carbon atoms, and
   wherein the flame retardant is the combination of aluminum dialkylphosphinate and aluminum salt of phosphorous acid, and wherein the alkyl contains 1-20 carbon atoms, preferably 2-8 carbon atoms.

In further preferred embodiment, the polyamide composition comprises:
(A) 20 to 45% by weight of a polyamide,
(B) 25 to 50% by weight of a polyketone,
(C) 15 to 20% by weight of a flame retardant, and
(D) 5 to 7% by weight of a flame retardant synergist,
   each being based on the total weight of the polyamide composition,
   wherein the polyamide is selected from the group consisting of a polyamide having repeating units of Formula (I), a polyamide having repeating units of Formula (II), and any combinations thereof:

[symbol]

NH—R¹—CO [symbol] Formula (I),

wherein

R¹ is a hydrocarbylene group having from 6 to 40 carbon atoms, preferably from 8 to 19 carbon atoms, more preferably from 8 to 12 carbon atoms;

[symbol]

NH—R²—NH—CO—R³—CO [symbol] Formula (II),

wherein
R² is a hydrocarbylene group having from 4 to 40 carbon atoms, preferably from 4 to 24 carbon atoms, more preferably from 4 to 18, most preferably from 4 to 14 carbon atoms,
R³ is a hydrocarbylene group having from 4 to 40 carbon atoms, preferably from 7 to 36 carbon atoms, more preferably from 8 to 20 carbon atoms, and
   wherein R² has more than 6 carbon atoms and/or R³ has more than 4 carbon atoms, and
   wherein the flame retardant is the combination of aluminum diethylphosphinate and aluminum salt of phosphorous acid.

In one preferred embodiment, the polyamide composition comprises:
(A) 20 to 45% by weight of a polyamide,
(B) 25 to 50% by weight of a polyketone,
(C) 15 to 20% by weight of a flame retardant, and
(D) 5 to 7% by weight of a flame retardant synergist,
   each being based on the total weight of the polyamide composition,
   wherein the polyamide is selected from the group consisting of a polyamide having repeating units of Formula (I), a polyamide having repeating units of Formula (II), and any combinations thereof:

[symbol]

NH—R¹—CO [symbol] Formula (I),

wherein
R¹ is a hydrocarbylene group having from 6 to 40 carbon atoms, preferably from 8 to 19 carbon atoms, more preferably from 8 to 12 carbon atoms;

[symbol]

NH—R²—NH—CO—R³—CO [symbol] Formula (II),

wherein
R² is a hydrocarbylene group having from 4 to 40 carbon atoms, preferably from 4 to 24 carbon atoms, more preferably from 4 to 18, most preferably from 4 to 14 carbon atoms,
R³ is a hydrocarbylene group having from 4 to 40 carbon atoms, preferably from 7 to 36 carbon atoms, more preferably from 8 to 20 carbon atoms, and
   wherein R² has more than 6 carbon atoms and/or R³ has more than 4 carbon atoms,
   wherein the flame retardant is organic phosphorus-based flame retardant, and
   wherein the flame retardant synergist is a halogen-containing flame retardant synergist.

In another preferred embodiment, the polyamide composition comprises:
(A) 20 to 45% by weight of a polyamide,
(B) 25 to 50% by weight of a polyketone,
(C) 15 to 20% by weight of a flame retardant, and
(D) 5 to 7% by weight of a flame retardant synergist,
   each being based on the total weight of the polyamide composition,
   wherein the polyamide is selected from the group consisting of a polyamide having repeating units of Formula (I), a polyamide having repeating units of Formula (II), and any combinations thereof:

[symbol]

NH—R¹—CO [symbol] Formula (I),

wherein
R¹ is a hydrocarbylene group having from 6 to 40 carbon atoms, preferably from 8 to 19 carbon atoms, more preferably from 8 to 12 carbon atoms;

[symbol]

NH—R²—NH—CO—R³—CO [symbol] Formula (II),

wherein
R² is a hydrocarbylene group having from 4 to 40 carbon atoms, preferably from 4 to 24 carbon atoms, more preferably from 4 to 18, most preferably from 4 to 14 carbon atoms,
R³ is a hydrocarbylene group having from 4 to 40 carbon atoms, preferably from 7 to 36 carbon atoms, more preferably from 8 to 20 carbon atoms, and
   wherein R² has more than 6 carbon atoms and/or R³ has more than 4 carbon atoms,
   wherein the polyketone has repeating units of Formula (V):

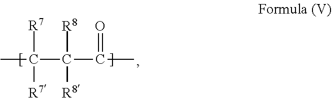

wherein R⁷, R^{7′}, R⁸ and R^{8′} are each independently hydrogen or hydrocarbyl groups having 1 to 20 carbon atoms, preferably 1 to 10 carbon atoms, and wherein the polyketone has a number average molecular weight (Mn) of less than 70,000, for example in the range from 10,000 to 70,000, 30,000 to 70,000, or 45,000 to 65,000,
wherein the flame retardant is organic phosphorus-based flame retardant, and
wherein the flame retardant synergist is a halogen-containing flame retardant synergist.

In further preferred embodiment, the polyamide composition comprises:
(A) 20 to 45% by weight of a polyamide,
(B) 25 to 50% by weight of a polyketone,
(C) 15 to 20% by weight of a flame retardant, and
(D) 5 to 7% by weight of a flame retardant synergist,
   each being based on the total weight of the polyamide composition,
   wherein the polyamide is selected from the group consisting of a polyamide having repeating units of Formula (I), a polyamide having repeating units of Formula (II), and any combinations thereof:

[symbol]

NH—R¹—CO [symbol] Formula (I),

wherein
R¹ is a hydrocarbylene group having from 6 to 40 carbon atoms, preferably from 8 to 19 carbon atoms, more preferably from 8 to 12 carbon atoms;

[symbol]

NH—R²—NH—CO—R³—CO [symbol] Formula (II),

wherein
R² is a hydrocarbylene group having from 4 to 40 carbon atoms, preferably from 4 to 24 carbon atoms, more preferably from 4 to 18, most preferably from 4 to 14 carbon atoms,
R³ is a hydrocarbylene group having from 4 to 40 carbon atoms, preferably from 7 to 36 carbon atoms, more preferably from 8 to 20 carbon atoms, and
   wherein R² has more than 6 carbon atoms and/or R³ has more than 4 carbon atoms,
   wherein the polyketone has repeating units of Formula (V):

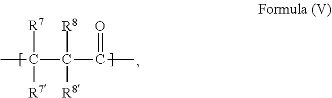

wherein R⁷, R^{7′}, R⁸ and R^{8′} are each independently hydrogen or hydrocarbyl groups having 1 to 20 carbon atoms, preferably 1 to 10 carbon atoms, and wherein the polyketone has a number average molecular weight (Mn) of less than 70,000, for example in the range from 10,000 to 70,000, 30,000 to 70,000, or 45,000 to 65,000,
wherein the flame retardant is metal dialkylphosphinate, and
wherein the flame retardant synergist is a halogen-containing flame retardant synergist.

In all embodiments described herein, the sum of content of each component in the polyamide composition is 100% by weight in total.

### Articles

The polyamide composition according to the present invention can be processed into various structures or forms by conventional methods to provide articles having flame retardancy. For example, the individual components of the polyamide composition according to the present invention can be mixed and then molded, for example via injection and/or extrusion in conventional mixing apparatus, such as screw extruders, Brabender mixers or Banbury mixers to form the articles. The mixing temperatures used herein are generally from 220° C. to 260° C.

It will be understood that all components of the polyamide composition can be mixed at the same time. Alternatively, some components of the polyamide composition can be pre-mixed and then mixed with other components. For example, all starting components of the polyamide composition except the flame retardant and the flame retardant synergist are mixed together in a stirrer and fed into a twin-screw extruder at the throat, then the flame retardant and the flame retardant synergist are pre-mixed and fed at downstream using a side feeder.

Accordingly, the present invention provides an article produced from the polyamide composition according to the present invention.

Articles according to the present invention have a UL94 V0 rating at 0.4 mm in thickness according to UL 94 vertical burning method.

It is preferred that the articles according to the present invention have one or more of following properties,
a moisture uptake of less than 0.8 measured according to ISO 62-2008.
a tensile modulus of greater than 2,200 GPa measured according to ISO 527-1-2012.
a tensile elongation (%) of greater than 8 measured according to ISO 527-1-2012.
a tensile strength of greater than 35 MPa measured according to ISO 527-1-2012.
a Charpy notched impact strength at 23° C. of at least 2 KJ/m² measured according to ISO 179-1-2010.
a Charpy unnotched impact strength at 23° C. of at least 30 KJ/m² measured according to ISO 179-1-2010.

The polyamide composition according to the present invention has good flame retardancy, low moisture uptake, and good mechanical properties, and no discoloration (e.g., yellowing) occurs during the extrusion or injection process.

Thus, the articles produced from the polyamide composition according to the present invention can be used in many fields, including but being not limited to, electrical, furniture, sports, mechanical engineering, sanitary and hygiene, medical, power engineering and drive technology, automobile and other means of transport, or housing material for equipment and apparatuses for telecommunications, consumer electronics, household devices, heating sectors, or fastening parts for installation work, or containers, or ventilation parts of any type.

The polyamide composition according to the present invention are suitable for the production of fibers, foils, tubes, films, and the like, in particular for applications such as plugs, switches, housing parts, housing covers, headlamp bezels, shower heads, fittings, smoothing irons, rotary switches, stove controls, fryer lids, door handles, (rear) mirror housings, (tailgate) screen wipers, sheathing for optical conductors.

Articles which can be produced with the polyamide composition according to the present invention can be used in electrical and electronic sectors for example plugs, plug parts, plug connectors, plug sleeve, cable harness components, circuit mounts, circuit mount components, three-dimensionally injection-molded circuit mounts, electrical connector elements, mechatronic components, and optoelectronic components.

Possible uses of the polyamide composition according to the present invention in automobile interiors are for dashboards, steering-column switches, seat parts, headrests, center consoles, gearbox components, and door modules, and possible uses in automobile exteriors are for door handles, headlamp components, exterior mirror components, windshield wiper components, windshield wiper protective housings, decorative grilles, roof rails, sunroof frames, and exterior bodywork parts.

The polyamide composition according to the present invention can also possibly used in the kitchen and household sectors, for example for production of components for kitchen equipment, e.g., fryers, smoothing irons, buttons, and also garden and leisure sector applications, such as components for irrigation systems or garden equipment.

### Embodiments

Various embodiments are listed below. It will be understood that the embodiments listed below can be combined with all aspects and other embodiments in accordance with the scope of the invention.

1. A polyamide composition, comprising:
(A) 10 to 60% by weight of a polyamide,
(B) 10 to 60% by weight of a polyketone,
(C) 5 to 25% by weight of a flame retardant, and
(D) 0.5 to 10% by weight of a flame retardant synergist,
   each being based on the total weight of the polyamide composition,
   wherein the polyamide has at least one type of structural units of more than 6 carbon atoms.

2. The polyamide composition according to embodiment 1, wherein the polyamide has at least one type of structural units of 7 to 40 carbon atoms, preferably 8 to 36 carbon atoms, more preferably 8 to 20 carbon atoms.

3. The polyamide composition according to embodiment 1 or 2, wherein the polyamide is selected from the group consisting of a polyamide having repeating units of Formula (I), a polyamide having repeating units of Formula (II), and any combinations thereof:

[symbol]

NH—R¹—CO [symbol] Formula (I),

wherein
R¹ is a hydrocarbylene group having from 6 to 40 carbon atoms, preferably from 8 to 19 carbon atoms, more preferably from 8 to 12 carbon atoms;

[symbol]

NH—R²—NH—CO—R³—CO [symbol] Formula (II),

wherein
R² is a hydrocarbylene group having from 4 to 40 carbon atoms, preferably from 4 to 24 carbon atoms, more preferably from 4 to 18, most preferably from 4 to 14 carbon atoms,
R³ is a hydrocarbylene group having from 4 to 40 carbon atoms, preferably from 7 to 36 carbon atoms, more preferably from 8 to 20 carbon atoms, and
   wherein R² has more than 6 carbon atoms and/or R³ has more than 4 carbon atoms.

4. The polyamide composition according to any of preceding embodiments, wherein the polyamide is selected from the group consisting of PA7, PA8, PA9, PA11, PA12, PA410, PA510, PA513, PA515, PA69, PA610, PA612, PA613, PA614, PA618, PA636, PA88, PA810, PA812, PA1010, PA1012, PA1014, PA1018, PA1210, PA1212, PA1214, PA1218, PA1313, PA1410, PA1412, PA1414, PA1418, and any combinations thereof, preferably PA410, PA510, PA513, PA515, PA69, PA610, PA612, PA613, PA614, PA618, PA636, PA88, PA810, PA812, PA1010, PA1012, PA1014, PA1018, PA1210, PA1212, PA1214, PA1218, PA1313, PA1410, PA1412, PA1414, PA1418, and any combinations thereof, even more preferably PA410, PA510, PA610, PA612, PA618, PA1010, PA1012, PA1210, PA1212, and any combinations thereof, further more preferably PA510, PA1010, and any combinations thereof.

5. The polyamide composition according to any of preceding embodiments, wherein the polyketone has repeating units of Formula (V):

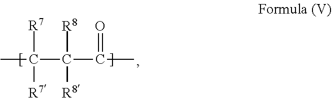

wherein R⁷, R^{7′}, R⁸ and R^{8′} are each independently hydrogen or hydrocarbyl groups having 1 to 20 carbon atoms, preferably 1 to 10 carbon atoms.

6. The polyamide composition according to any of preceding embodiments, wherein the polyketone has a number average molecular weight (Mn) of less than 100,000, preferably less than 70,000, for example in the range from 10,000 to 70,000, 30,000 to 70,000, or 45,000 to 65,000.

7. The polyamide composition according to any of preceding embodiments, wherein the flame retardant comprises inorganic flame retardants, phosphorus-containing flame retardant, halogen-containing flame retardant, nitrogen-containing flame retardants, or any combinations thereof.

8. The polyamide composition according to embodiment 7, wherein the flame retardant comprises metal dialkylphosphinate, halogenated polyacrylate, or any combinations thereof.

9. The polyamide composition according to any of preceding embodiments, wherein the flame retardant synergist comprises melamine cyanurate, antimony trioxide, aluminum hydroxide, magnesium hydroxide, zinc borate, polysiloxane, alumina, calcium borate, calcium carbonate, calcium magnesium carbonate, calcium oxide, calcium sulfide, iron oxide, magnesium borate, magnesium carbonate, magnesium nitride, magnesium oxide, magnesium sulfide, manganese hydroxide, manganese oxide, titanium nitride, titanium dioxide, zinc metaborate, zinc carbonate, zinc hydroxide, zinc nitrate, zinc oxide, zinc phosphate, zinc sulfide, zinc stannate, zinc hydroxystannate, base zinc silicate, tin oxide hydrate, or any combinations thereof.

10. The polyamide composition according to any of preceding embodiments, wherein the polyamide composition comprises 15 to 50% by weight of polyamide, preferably 20 to 45% by weight of polyamide.

11. The polyamide composition according to any of preceding embodiments, wherein the polyamide composition comprises 20 to 55% by weight of polyketone, preferably 25 to 50% by weight of polyketone.

12. The polyamide composition according to any of preceding embodiments, wherein the polyamide composition comprises 10 to 25% by weight of flame retardant, preferably 15 to 20% by weight of flame retardant.

13. The polyamide composition according to any of preceding embodiments, wherein the polyamide composition comprises 1 to 9% by weight of flame retardant synergist, preferably 3 to 8% by weight of flame retardant synergist, more preferably 5 to 7% by weight of flame retardant synergist.

14. The polyamide composition according to any of preceding embodiments, wherein the polyamide composition further comprises at least one additive selected from the group consisting of lubricants, antioxidants, colorants such as dyes and/or pigments, release agents, reinforcing agents such as glass fibers, impact modifiers, compatibilizing agents, thermostabilizers, photostabilizers such as UV stabilizers, plasticizers, surfactants, nucleating agents, coupling agents, antimicrobial agents, antistatic agents, and any combinations thereof.

15. An article produced from the polyamide composition according to any of embodiments 1 to 14.

16. The article according to embodiment 15, wherein the article has a UL94 V0 rating at 0.4 mm in thickness according to UL 94 vertical burning method.

17. The article according to embodiment 15 or 16, wherein the article has a moisture uptake of less than 0.8 measured according to ISO 62-2008.

18. The article according to any of embodiments 15 to 17, wherein the articles are in the form of fibers, foils, films or pipes.

19. The article according to any of embodiments 15 to 18, wherein the articles are used in electrical and electronic sectors for example plugs, plug parts, plug connectors, plug sleeve, cable harness components, circuit mounts, circuit mount components, three-dimensionally injection-molded circuit mounts, electrical connector elements, mechatronic components, and optoelectronic components.

### Examples

Aspects of the present invention are more fully illustrated by the following examples, which are set forth to illustrate certain aspects of the present invention and are not to be construed as limiting thereof.

Following materials and test methods were used in the Examples.

### Materials:

TABLE 1
The materials used in the inventive examples and comparative examples

| Acronym/Name | Description |
|---|---|
| A1: PA510 | TERRYL ®PA510 from Cathay Biotech Inc, relative viscosity is |
| | 2.46 measured in 98 wt % sulfuric acid solution at 25° C., Tm is |
| | 220° C. |
| A2: PA1010 | PA1010 from Shandong Dongchen Engineering Plastic Co., Ltd, |
| | relative viscosity is 2.2-2.5 measured in 98 wt % sulfuric acid |
| | solution at 25° C., Tm is 205° C. |
| A3: PA6 | Libolon N130 from LI PENG Enterprise CO., LTD, relative viscosity |
| | is 2.2 measured in 98 wt % sulfuric acid solution at 25° C., Tm is |
| | 220° C. |
| B1: POK | Aliphatic polyketone M930A from Hyosung Co. Ltd, Mn is 60,000 |
| | g/mol, Mw is 132000 g/mol and polydispersity is 2.2, melt flow rate |
| | is 200 g/10 min measured at 240° C. with 2.16 kg |
| B2: POK | Aliphatic polyketone M630A from Hyosung Co. Ltd, Mn is 100,000 |
| | g/mol, Mw is 320000 g/mol and polydispersity is 3.2, melt flow rate |
| | is 6 g/10 min measured at 240° C. with 2.16 kg |
| B3: PPO | LXR035 from China National Bluestar (Group) Co, Ltd with Mw of |
| | 22000 to 28000 g/mol and glass transition temperature of 210° C. |
| B4: PET | A9203 from Toray, intrinsic viscosity is 0.65 dL/g measured |
| | according to ISO1628 |
| C1: OP1230 | Exolit OP1230 from Clariant plastics & Coating Ltd., made of |
| | aluminum salt of diethyl-phosphinic acid |
| C2: Brominated | FR-1025 from ICL, 2-Propenoic acid, (2,3,4,5,6-bromophenyl) |
| polyacrylate | methyl ester, homopolymer |
| D1: MC | BUDIT 315 E from Budenheim Iberica, S. L., Melamine Cyanurate |
| D2: Sb₂O₃ | GM-F01 from Gredmann Fine Chemical Ltd. Antimony trioxide/ |
| | LDPE 90/10 masterUJbatch |
| E1, AO1098 | Antioxidant, BNX 1098 from Mayzo Inc. |
| E2, EBS | Lubricant, N,N′-Ethylene bis(stearamide) from Croda Trading Co., |
| | Ltd. |
| E3, TiO₂ | Colorant, KRONOS ® 2220 from KRONOS, Inc. titanium dioxide |
| E4, Glass fiber (GF) | Glass fiber, ECS301HP-3-H, from Chongqing Polycomp |
| | international corporation |

### Measurements:

1. Tensile strength, tensile modulus and tensile elongation were measured according to ISO 527-1-2012. Test specimens of type 1 having thickness of 4 mm described in ISO 527-1-2012 were used. Charpy notched impact strength and Charpy unnotched impact strength were measured according to ISO 179-1-2010 via edgewise impact. The test specimens for Charpy unnotched test is type 1 specimen with the dimensions of 80*10*4 mm (length*width*thickness). The test specimens for Charpy notched test are type 1 with notched type A. All the test specimens were conditioned at 23° C. and 50% relative humidity for 16 h. The tests were conducted under the same atmosphere as conditioning.

2. The UL flame retardancy rating was measured according to UL 94 vertical burning method with sample sizes of 127 mm*12.7 mm*0.4 mm (length*width*thickness).

3. Moisture uptake was measured according to ISO 62-2008 with weight measurement after immersing in the water of 23° C. for 24 hours.

4. Discoloration was measured by eye observation of the molded color plaque (60×60×2 mm) with little discoloration marked as “+”, medium discoloration marked as “++” and severe discoloration marked as “+++”.

The test specimens used are made according to the following general procedure for preparing the test specimens.

### General Procedure for Preparing the Test Specimens

Test specimens were prepared in accordance with the formulations as shown in Table 2. All raw materials except the flame retardant and the flame retardant synergist were mixed together in a Tubula T50A high-speed stirrer and fed into a Coperion ZSK26MC twin-screw extruder at the throat, and the flame retardant and the flame retardant synergist were pre-mixed and fed at downstream using a side feeder, then melt-extruded under a temperature of 250° C., and pelletized, thus obtaining a polyamide composition in a pellet form.

The dried pellets of the polyamide composition were processed in an injection molding machine (KM130CX, from Krauss Maffei) with a clamping force of 130T at melt temperatures of 220° C. to 260° C. to provide a test specimen.

The obtained test specimens were measured for the properties as described above. The test results and the formulations for the preparation of the test specimens are summarized in Table 2.

TABLE 2

| Component, wt. % | E1 | E2 | E3 | E4 | C1 | C2 | C3 | C4 | C5 | C6 | C7 | C8 | C9 | C10 |
|---|---|---|---|---|---|---|---|---|---|---|---|---|---|---|
| A1: PA510 | 30.7 | 45.7 | | 45.7 | | 70.7 | 45.7 | 45.7 | | 20 | | | | |
| A2: PA1010 | | | 20 | | | | | | | | | | | |
| A3: PA6 | | | | | | | | | 82.7 | 50.7 | 60.7 | 50.7 | 79.36 | 55.36 |
| B1: POK | 40 | 25 | 50.7 | 25 | 70.7 | | | | | | 10 | 20 | | |
| B2: POK | | | | | | | | | | | | | 19.84 | 13.84 |
| B3: PPO | | | | | | | 25 | | | | | | | |
| B4: PET | | | | | | | | 25 | | | | | | |
| C1: OP1230 | 18 | 18 | 18 | | 18 | 18 | 18 | 18 | | 18 | 18 | 18 | | |
| C2: Brominated | | | | 18 | | | | | | | | | | |
| polyacrylate | | | | | | | | | | | | | | |
| D1: MC | 6 | 6 | 6 | | 6 | 6 | 6 | 6 | 12 | 6 | 6 | 6 | | |
| D2: Sb₂O₃ | | | | 6 | | | | | | | | | | |
| E1: AO1098 | 0.2 | 0.2 | 0.2 | 0.2 | 0.2 | 0.2 | 0.2 | 0.2 | 0.2 | 0.2 | 0.2 | 0.2 | 0.4 | 0.4 |
| E2: EBS | 0.6 | 0.6 | 0.6 | 0.6 | 0.6 | 0.6 | 0.6 | 0.6 | 0.6 | 0.6 | 0.6 | 0.6 | 0.4 | 0.4 |
| E3: TiO₂ | 4.5 | 4.5 | 4.5 | 4.5 | 4.5 | 4.5 | 4.5 | 4.5 | 4.5 | 4.5 | 4.5 | 4.5 | | |
| E4: GF | | | | | | | | | | | | | | 30 |

Properties

| | | | | | | | | | | | | | | |
|---|---|---|---|---|---|---|---|---|---|---|---|---|---|---|
| Tensile | 2840 | 2860 | 2490 | 2390 | 2660 | 3180 | 3040 | 3320 | 3500 | 3760 | 3820 | 3470 | | |
| Modulus | | | | | | | | | | | | | | |
| (GPa) | | | | | | | | | | | | | | |
| Tensile | 40 | 42 | 38 | 54 | 35 | 46 | 46 | 32 | 69 | 51 | 50 | 44 | | |
| Strength | | | | | | | | | | | | | | |
| (MPa) | | | | | | | | | | | | | | |
| Tensile | 17 | 10 | 8.5 | 15 | 4 | 6.5 | 2.6 | 1.2 | 10 | 6 | 15 | 10 | | |
| elongation | | | | | | | | | | | | | | |
| (%) | | | | | | | | | | | | | | |
| Moisture | 0.5 | 0.7 | 0.4 | 0.7 | 0.3 | 1.1 | 0.6 | 0.7 | 1.8 | 1.4 | 1.6 | 1.3 | | |
| uptake (%) | | | | | | | | | | | | | | |
| Charpy | 2.7 | 2.6 | 2.5 | 3 | 2.2 | 2.4 | 1.4 | 0.8 | 4.8 | 2.6 | 2.8 | 2.3 | | |
| notched | | | | | | | | | | | | | | |
| impact | | | | | | | | | | | | | | |
| strength | | | | | | | | | | | | | | |
| (kJ/m²) | | | | | | | | | | | | | | |
| Charpy | 44 | 33 | 30 | 49 | 25 | 26 | 15 | 7.8 | 86 | 35 | 55 | 41 | | |
| unnotched | | | | | | | | | | | | | | |
| impact | | | | | | | | | | | | | | |
| strength | | | | | | | | | | | | | | |
| (kJ/m²) | | | | | | | | | | | | | | |
| FR UL94 VX | V0 | V0 | V0 | V0 | V0 | Fail | V2 | V0 | V0 | V2 | V0 | V0 | | |
| (rating) | | | | | | | | | | | | | | |
| Discoloration | ++ | ++ | + | ++ | + | + | ++ | + | + | + | +++ | +++ | +++ | +++ |
| (rating) | | | | | | | | | | | | | | |

E: Inventive Example;
C: Comparative Example

It can be seen from Table 2 that the inventive examples E1-E4 using a combination of PA and POK according to the present invention achieve good flame retardancy (UL94 V0), low moisture uptake, and good mechanical properties. While the comparative example C₁ using POK alone achieves good flame retardancy (UL94 V0) and low moisture uptake, its overall mechanical properties are lower than that of the inventive examples, especially its tensile elongation is significantly lower relative to the inventive examples. While the comparative example C2 using PA510 alone achieves good mechanical properties, its flame retardancy is poorer, its moisture uptake is higher, and its tensile elongation is lower, relative to the inventive examples.

The comparative example C3 is same to the inventive example E2 except that POK used in E2 is replaced by PPO in C3. It can be seen from Table 2 that the flame retardancy (UL94 V2), the tensile elongation, the Charpy notched impact strength and the Charpy unnotched impact strength of C3 are lower than those of E2, especially the flame retardancy, the tensile elongation, and the Charpy unnotched impact strength.

The comparative example C4 is same to the inventive example E2 except that POK used in E2 is replaced by PET in C4. It can be seen from Table 2 that the tensile strength, the tensile elongation, the Charpy notched impact strength and the Charpy unnotched impact strength of C4 are lower than that of E2, especially the tensile elongation and the Charpy unnotched impact strength.

While the comparative example C5 using PA6 alone achieves good flame retardancy and good mechanical properties, the moisture uptake of the comparative example C5 is significantly higher relative to the inventive examples.

While the comparative example C6 using a combination of PA6 and PA510 has good mechanical properties, its moisture uptake is higher relative to the inventive examples, and its flame retardancy becomes poor (UL94 V2) even though the comparative example C6 uses higher amount of flame retardant and flame retardant synergist in total relative to the comparative example C5.

The comparative examples C7 and C8 using a combination of PA6 (non-inventive PA) and POK (inventive POK) have higher moisture uptake relative to the inventive examples using a combination of PA510/PA1010 (inventive long chain PA) and POK (inventive POK). Particularly, severe discoloration (i.e., yellowing) occurs in the comparative examples C7 and C8, while only little discoloration or medium discoloration occurs in the inventive examples.

The comparative examples C9 and C10 using a combination of PA6 (non-inventive PA) and POK (non-inventive POK) have severe discoloration (i.e., yellowing) and it is difficult to process.

Accordingly, only the inventive examples using the combination of PA and POK according to the present invention show excellent balance among flame retardancy, mechanical properties, moisture uptake and color stability.

It will be apparent to one of ordinary skill in the art that various modifications and variations can be made in the present invention without departing from the scope or spirit of the present invention. It is intended that the embodiments and examples be considered as exemplary only. Thus, it is intended that the present invention covers such modifications and variations as come within the scope of the appended claims and their equivalents.

1. A polyamide composition, comprising:
(A) 10 to 60% by weight of a polyamide,
(B) 10 to 60% by weight of a polyketone,
(C) 5 to 25% by weight of a flame retardant, and
(D) 0.5 to 10% by weight of a flame retardant synergist,
each being based on the total weight of the polyamide composition,
wherein the polyamide has at least one type of structural units of more than 6 carbon atoms.

2. The polyamide composition according to claim 1, wherein the polyamide has at least one type of structural units of 7 to 40 carbon atoms.

3. The polyamide composition according to claim 1, wherein the polyamide is selected from the group consisting of a polyamide having repeating units of Formula (I), a polyamide having repeating units of Formula (II), and any combinations thereof: [symbol]
NH—R¹—CO [symbol] Formula (I),
wherein
R¹ is a hydrocarbylene group having from 6 to 40 carbon atoms; [symbol]
NH—R²—NH—CO—R³—CO [symbol] Formula (II),
wherein
R² is a hydrocarbylene group having from 4 to 40 carbon atoms,
R³ is a hydrocarbylene group having from 4 to 40 carbon atoms, and
wherein R² has more than 6 carbon atoms and/or R³ has more than 4 carbon atoms.

4. The polyamide composition according to claim 1, wherein the polyamide is selected from the group consisting of PA7, PA8, PA9, PA11, PA12, PA410, PA510, PA513, PA515, PA69, PA610, PA612, PA613, PA614, PA618, PA636, PA88, PA810, PA812, PA1010, PA1012, PA1014, PA1018, PA1210, PA1212, PA1214, PA1218, PA1313, PA1410, PA1412, PA1414, PA1418, and any combinations thereof.

5. The polyamide composition according to claim 1, wherein the polyketone has repeating units of Formula (V): 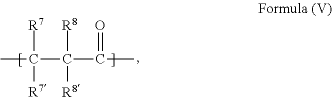
wherein R⁷, R^{7′}, R⁸ and R^{8′} are each independently hydrogen or hydrocarbyl groups having 1 to 20 carbon atoms.

6. The polyamide composition according to claim 1, wherein the polyketone has a number average molecular weight (Mn) of less than 100,000.

7. The polyamide composition according to claim 1, wherein the flame retardant comprises inorganic flame retardants, phosphorus-containing flame retardant, halogen-containing flame retardant, nitrogen-containing flame retardants, or any combinations thereof.

8. The polyamide composition according to claim 7, wherein the flame retardant comprises metal dialkylphosphinate, halogenated polyacrylate, or any combinations thereof.

9. The polyamide composition according to claim 1, wherein the flame retardant synergist comprises melamine cyanurate, antimony trioxide, aluminum hydroxide, magnesium hydroxide, zinc borate, polysiloxane, alumina, calcium borate, calcium carbonate, calcium magnesium carbonate, calcium oxide, calcium sulfide, iron oxide, magnesium borate, magnesium carbonate, magnesium nitride, magnesium oxide, magnesium sulfide, manganese hydroxide, manganese oxide, titanium nitride, titanium dioxide, zinc metaborate, zinc carbonate, zinc hydroxide, zinc nitrate, zinc oxide, zinc phosphate, zinc sulfide, zinc stannate, zinc hydroxystannate, base zinc silicate, tin oxide hydrate, or any combinations thereof.

10. The polyamide composition according to claim 1, wherein the polyamide composition comprises 15 to 50% by weight of polyamide.

11. The polyamide composition according to claim 1, wherein the polyamide composition comprises 20 to 55% by weight of polyketone.

12. The polyamide composition according to claim 1, wherein the polyamide composition comprises 10 to 25% by weight of flame retardant.

13. The polyamide composition according to claim 1, wherein the polyamide composition comprises 1 to 9% by weight of flame retardant synergist.

14. The polyamide composition according to claim 1, wherein the polyamide composition further comprises at least one additive selected from the group consisting of lubricants, antioxidants, colorants, dyes and/or pigments, release agents, reinforcing agents, glass fibers, impact modifiers, compatibilizing agents, thermostabilizers, photostabilizers, UV stabilizers, plasticizers, surfactants, nucleating agents, coupling agents, antimicrobial agents, antistatic agents, and any combinations thereof.

15. An article produced from the polyamide composition according to claim 1.

16. The article according to claim 15, wherein the article has a UL94 V0 rating at 0.4 mm in thickness according to UL 94 vertical burning method.

17. The article according to claim 15, wherein the article has a moisture uptake of less than 0.8 measured according to ISO 62-2008.

18. The article according to claim 15, wherein the articles are in the form of fibers, foils, films or pipes.

19. The article according to claim 15, wherein the article is used in electrical and electronic sectors.

20. The article according to claim 15, wherein the article is selected from the group consisting of plugs, plug parts, plug connectors, plug sleeve, cable harness components, circuit mounts, circuit mount components, three-dimensionally injection-molded circuit mounts, electrical connector elements, mechatronic components, and optoelectronic components.
